(19) United States
(12) Patent Application Publication
(10) Pub. No.: US 2025/0258028 A1
(43) Pub. Date: Aug. 14, 2025

(54) ULTRASONIC METER

(71) Applicant: SENSUS SPECTRUM LLC, Morrisville, NC (US)

(72) Inventors: Christopher DAWSON, Shefford (GB); Benjamin DAVEY, Cambridge (GB); James HAWKESFORD, Cambridge (GB); Charlie PATERSON, Cambridge (GB); Paul DUNAWAY, Cambridge (GB); David HEALY, Stowmarket (GB); Matthew BOXALL, Cambridge (GB)

(21) Appl. No.: 18/856,388

(22) PCT Filed: Apr. 11, 2023
(86) PCT No.: PCT/GB2023/050967

§ 371 Date: Oct. 11, 2024

(30) Foreign Application Priority Data
Apr. 12, 2022 (GB) 2205409.2

(51) Int. Cl. G01F 1/667; G01F 1/66

(52) U.S. Cl. CPC G01F 1/667; G01F 1/662

(57) ABSTRACT

An ultrasonic meter (44) is described for measuring a flow-rate of a fluid, including a flow conduit (5) for the fluid. The flow conduit (5) extends along a first axis (6) 5 between a first opening (7) and a second opening (8). The ultrasonic meter (44) also includes two or more pairs of ultrasonic transducers (2, 3). Each pair of ultrasonic transducers (2, 3) is configured to define a corresponding beam path (9) intersecting the flow conduit (5) within a measurement region (13) of the flow conduit (5). Substantially every part of each beam path (9) makes a non-zero angle with the first 10 axis (6). When viewed projected onto a plane perpendicular to the first axis (6), a projection of a first beam path (91) intersects (25) a projection of a second beam path (92). The ultrasonic meter (44) also includes a flow deflecting member (26) supported between the first opening (7) and the measurement region (13). When viewed projected onto the plane perpendicular to the first axis (6), a projection of the flow 15 deflecting member (26) at least partially overlaps the intersection (25) of the projections of the first and second beam paths (91, 92).

### FIELD OF THE INVENTION

The present invention relates to ultrasonic flow rate meters. In particular, the present invention relates to reducing sensitivity of ultrasonic meters to flow conditions which deviate from calibration conditions.

### BACKGROUND

Ultrasonic flow rate meters have been constructed which measure a flow velocity/speed of a liquid or gas based on time-of-flight measurements. Sometimes a pair of ultrasonic transducers is arranged at opposite ends of a flow tube having a known length. Alternatively, a pair of ultrasonic transducers may be arranged spaced apart along the length of a flow tube by a distance, the ultrasonic transducers arranged at angles to the flow tube such that ultrasound may pass between the pair by reflecting from an internal wall or reflector of the flow tube. By obtaining time-of-flight measurements between the ultrasonic transducers both with, and against, the flow direction of the liquid or gas, a difference may be obtained which relates to the flow speed of the liquid or gas.

Only a fraction of the liquid or gas (hereinafter both shall be encompassed by the term “fluid”) passes through the ultrasonic beam. Consequently, the flow speed measured represents an average over the volume sampled by the ultrasonic beam. In order to convert such an average flow speed to a mass flow of the fluid, for example to allow metering of the fluid, a velocity/speed profile of the fluid must be assumed. When a fluid flows down a straight section of pipe with uniform cross-section, the velocity/speed profile across the pipe will tend towards a predictable profile after flowing for a sufficiently large distance (typically several times a diameter or similar characteristic dimension). Thus, when an ultrasonic meter is installed in, or on, a long straight section of pipe, the approach of assuming a velocity/speed profile may work reasonably well. However, features such as bends, constrictions, valves, pumps and so forth upstream of an ultrasonic meter may cause the velocity/speed profile in a pipe to deviate from the expected profile, reducing the accuracy of the ultrasonic meter. Since a sufficiently long, straight section of pipe may not be available, the accuracy and/or possible installation locations of ultrasonic flow meters may be restricted

One approach for improving the predictability of a velocity/speed profile is to place one or more flow conditioners upstream (and sometimes also downstream) of an ultrasonic meter. For example, EP 1775 560 A2 describes an ultrasonic flow meter including a flow passage, an ultrasound transducer and a flow straightener for removing or diminishing flow disturbances such as swirls. The flow straightener includes at least a first and a second straightening means being oppositely twisted along a flow direction with a given twisting angle. “Flow conditioning and effects on accuracy for fluid flow measurement”, B. D. Sawchuck, D. P. Sawchuck, D. A. Sawchuk, American School of Gas Measurement Technology, 2010, p 1-9, describes the results of testing a flow conditioner.

WO 2019/229409 A1 describes ultrasonic meters and inserts which use protrusions within a flow conduit to displace a greater fraction of fluid flow through one or more beam paths. This reduces the sensitivity of an ultrasonic meter to deviations from straight flow conditions.

### SUMMARY

According to a first aspect of the invention, there is provided an ultrasonic meter for measuring a flow-rate of a fluid, including a flow conduit for the fluid. The flow conduit extends along a first axis between a first opening and a second opening. The ultrasonic meter also includes two or more pairs of ultrasonic transducers. Each pair of ultrasonic transducers is configured to define a corresponding beam path intersecting the flow conduit within a measurement region of the flow conduit. Substantially every part of each beam path makes a non-zero angle with the first axis. When viewed projected onto a plane perpendicular to the first axis, a projection of a first beam path intersects a projection of a second beam path. The ultrasonic meter also includes a flow deflecting member supported between the first opening and the measurement region. When viewed projected onto the plane perpendicular to the first axis, a projection of the flow deflecting member at least partially overlaps the intersection of the projections of the first and second beam paths.

In this way, the flow deflecting member acts to deflect fluid flows which would be sampled by the first beam path and the second beam path. The two or more pairs of ultrasonic transducers may define two or more beam paths, including at least the first and second beam paths.

Substantially every part of each beam path may be considered to make a non-zero angle with the first axis when 75% or more, 80% or more, 90% or more, or 95% or more of the beam path length corresponds to parts which make a non-zero angle with the first axis. Every part of each beam path, i.e. the entire length, may make a non-zero angle with the first axis.

When a part of a beam path make a non-zero angle with the first axis, that non-zero angle may be between 10 degrees and 80 degrees (inclusive of end-points) to the first axis. Each beam path may be configured so that within the measurement region, each part of each beam path which intersects the measurement region includes a component parallel to the first axis and a component transverse to the first axis.

When viewed projected onto the plane perpendicular to the first axis, the projection of the flow deflecting member may not divide a projection of the flow conduit into two separate regions.

When viewed projected onto the plane perpendicular to the first axis, the projection of the flow deflecting member may divides a projection of the flow conduit into two or more separate regions including a primary region. An area of the primary region in the projection may account for 75% or more of the total projected area of the two or more separate regions. The area of the primary region in the projection may account for 80% or more of the total projected area of the two or more separate regions. The area of the primary region in the projection may account for 85% or more of the total projected area of the two or more separate regions. The area of the primary region in the projection may account for 90% or more of the total projected area of the two or more separate regions. The area of the primary region in the projection may account for 95% or more of the total projected area of the two or more separate regions. The projection of the flow deflecting member may divide a projection of the flow conduit into exactly two separate regions including the primary region. The projection of the flow deflecting member may divide a projection of the flow conduit into exactly three separate regions including the primary region.

When viewed projected onto the plane perpendicular to the first axis, the projection of the flow deflecting member may at least partially overlap a peak flow region of the plane. The peak flow region may be defined relative to a projection onto the plane of a flow conduit of a reference ultrasonic meter which is identical to the ultrasonic meter except for omitting the flow deflecting member. The peak flow region may correspond to a region of the plane in which a flow speed through the reference ultrasonic meter is above a mean flow speed in response to passing a steady state fluid flow through the reference ultrasonic meter at a Reynolds number of approximately 3000. Reynolds number may be determined from theory, simulations (e.g. finite element analysis) and/or experiments.

The mean flow speed may be determined by measuring the volumetric flowrate though the conduit of the reference ultrasonic meter and dividing by a cross-sectional area (projected area on the plane) of the flow conduit. Alternatively, flow velocities through the reference ultrasonic meter may be simulated, for example using finite element analysis. The simulated flow velocities may then be integrated over the volume and the flow conduit and normalised to the total volume of the flow conduit to obtain the mean flow speed. Simulated flow velocities may include, or take the form of, a vector field, v(x,y,z), of fluid velocities. A projection of the flow velocity field onto the plane perpendicular to the first axis may be defined as:

$${v}^{*} ( x , y ) = {\int }_{0}^{L} \frac{\underline{v} ( x , y , z ) \cdot \hat{\underline{z}}}{L} d z$$

In which the unit vector \hat{z} is aligned with the first axis, L is the length of the fluid conduit parallel to the first axis and v* is a projected flow speed map. The peak flow region may be defined based on the region(s) of the projected flow speed map in which the projected flow speed exceeds the mean flow speed.

The projected area of the reference meter is identical in shape and orientation to that of the ultrasonic meter. In other words, the peak flow region is defined relative to the flow profile which would result if the flow deflecting member were removed. A steady state fluid flow corresponds to the flow that would be found in a long straight pipe having a cross section corresponding to the projected area of the flow conduit. In other words, sufficiently far (e.g. at least ten times longer than a maximum dimension perpendicular to the first axis) from any disturbances resulting from bends, variations in cross sectional area, shape, and so forth. A Reynolds number of approximately 3000 may mean within ±10%, or within ±5%.

Instead of the peak flow region corresponding to flow velocities greater than or equal to the mean flow speed in the reference ultrasonic meter, the peak flow region may instead be defined to correspond to higher flow velocities. For example, if the mean flow speed in the reference ultrasonic meter is U_{avg} and the maximum is Uₘₐₓ, the peak flow region may be defined to correspond to flow velocities greater than or equal to U_{avg}+f(Uₘₐₓ−U_{avg}) with f equal to 0.1, 0.2, 0.25, 0.3, 0.4, 0.5, 0.6, 0.7, 0.75, 0.8, or 0.9.

Flow speed profiles in the reference ultrasonic meter in response to steady state fluid flow through the reference ultrasonic meter at a Reynolds number of approximately 3000 may be determined from theory, simulations and/or experimental measurements.

The Reynolds number may be defined as the product of the mean flow speed and the hydraulic diameter, divided by the kinematic viscosity of the fluid, for example water, at a test temperature. It may be noted that the temperature is not important, since if the temperature changes, then the flow rate must change correspondingly to maintain the Reynolds number at the same value (and hence the same flow profile). Hydraulic diameter is defined as four times the area of the flow conduit (perpendicular to the first axis), divided by the perimeter around that area. For a flow conduit in the form of a cylinder, the hydraulic diameter is the cylinder diameter, however, the same definition is applicable to non-cylindrical flow conduits.

Alternatively, the peak flow region may be approximately defined without consideration of fluid flows through the reference ultrasonic meter. For example, the peak flow region may be defined as a region which:
is concentric with the projection of the flow conduit;
is circular, or has the same shape and orientation as the projection of the flow conduit; and
has one quarter or less of an area of the projection of the flow conduit.

When viewed projected onto the plane perpendicular to the first axis, at least half the projected area of the flow deflecting member may overlap the peak flow region.

The flow deflecting member may be separated from the measurement region by a distance along the first axis which is between zero and 5 times a maximum dimension of the flow conduit perpendicular to the first axis. The separation of the flow deflecting member from the measurement region may be no more than 4 times, no more than 3 times, no more than 2 times, no more than equal to, or no more than half the maximum dimension of the flow conduit perpendicular to the first axis.

A leading side of the flow deflecting member facing towards the first opening may have a rounded bevel profile around at least part of its perimeter and/or may taper towards the first opening. The rounded bevel profile may extend around all of the perimeter of the leading side.

A trailing side of the flow deflecting member facing towards the measurement region may have a sharp edge around at least part of its perimeter. The sharp edge around at least part of the perimeter of the trailing side may correspond to a Kamm-tail profile. The sharp edge may extend around all of the perimeter of the trailing side. The sharp edge may extend around the portion of the perimeter of the trailing side corresponding to the blocking member defined hereinafter. The remainder of the perimeter of the trailing side may configured for streamlining.

Along one, some or all edges of the second side, the flow deflecting member may exhibit a rounded profile, for example a filet or chamfer having a characteristic dimension between 0 mm and 0.25 times a dimension of the flow deflecting member perpendicular to the first axis.

When viewed projected onto a plane parallel to the first axis, the flow deflecting member may have a quadrilateral shape. The plane parallel to the first axis may also be parallel to a mirror plane of the flow deflecting member.

The quadrilateral shape may have a first side parallel to the first axis and disposed at or near an outer wall of the flow conduit, a second side parallel to the first axis and shorter than the first side, a third (or “leading”) side facing towards the first opening and making a first internal angle to the first side, and a fourth (or “trailing”) side facing towards the measurement region and making a second internal angle to the first side. The first and second angles may be equal. The first and second angles may be different. The first angle may be between 45 and 80 degrees (inclusive of endpoints). The second angle may be between 45 and 135 degrees (inclusive of endpoints).

The quadrilateral shape may be a trapezium shape. The quadrilateral shape may be a parallelogram shape.

The flow deflecting member may include a blocking member disposed within the fluid conduit and held in place by a supporting member. The blocking member and the supporting member may be integrally formed. The blocking member and the supporting member may be separate structures bonded, welded or otherwise attached to one another. When viewed projected onto the plane perpendicular to the first axis, a projection of the blocking member at least partially overlaps the intersection between projections of the first and second beam paths. The supporting member may connect the blocking member to an interior surface of the fluid conduit. The supporting member may connect the blocking member to an annular insert received within the fluid conduit.

One or more through-holes may be formed through the supporting member to permit passage of fluid. A through-hole may extend through the supporting member parallel to the first axis. A through-hole formed through the supporting member may be elliptical or circular in cross-section (when projected onto the plane perpendicular to the first axis). A through-hole formed through the supporting member may be square or rectangular in cross-section (when projected onto the plane perpendicular to the first axis). A through-hole formed through the supporting member may take the form of a slot.

When viewed projected onto the plane perpendicular to the first axis, the projections of the through-hole(s) may correspond to 25% or less of a total projected flow area formed by subtracting the projection of the flow deflecting member from the projection of the flow conduit. When viewed projected onto the plane perpendicular to the first axis, the projections of the through-hole(s) may correspond to 20% or less of a total projected flow area formed by subtracting the projection of the flow deflecting member from the projection of the flow conduit. When viewed projected onto the plane perpendicular to the first axis, the projections of the through-hole(s) may correspond to 15% or less of a total projected flow area formed by subtracting the projection of the flow deflecting member from the projection of the flow conduit. When viewed projected onto the plane perpendicular to the first axis, the projections of the through-hole(s) may correspond to 10% or less of a total projected flow area formed by subtracting the projection of the flow deflecting member from the projection of the flow conduit. When viewed projected onto the plane perpendicular to the first axis, the projections of the through-hole(s) may correspond to 5% or less of a total projected flow area formed by subtracting the projection of the flow deflecting member from the projection of the flow conduit.

When viewed projected onto the plane perpendicular to the first axis, a projection of the supporting member may connect to a projection of the blocking member along a connection direction. A maximum dimension of the projection of the blocking member perpendicular to the connection direction may be greater than a maximum dimension of the projection of the supporting member perpendicular to the connection direction.

The flow deflecting member may include, or take the form of, a radial member extending inwards from an inner surface of the flow conduit, and a blocking member disposed within the fluid conduit and offset along the first axis away from the first opening relative to the radial member. The blocking member may be held in place by a rod or wire extending along the first axis from the radial member to the blocking member.

The radial member may be streamlined or otherwise shaped to minimise disruption to incident fluid flow. In this way, and combined with offsetting the blocking member downstream of the protruding member, the disruption to fluid flow of the radial member may be minimised so that the influence of the flow deflecting member on fluid flows is more dominated by the effect of the blocking member.

When the blocking member is connected to the radial member by a wire, a leading edge (relative to the first opening and the radial member) of the blocking member may be shaped such that a position of the blocking member within the flow conduit will be stabilised by fluid flow from the first opening towards the second opening. The blocking member may have a leading edge which is conical/pyramidal or frustoconical/frustopyramidal.

The flow deflecting member may include, or take the form of, a blocking member disposed within the fluid conduit and held in place by two or more supporting members. The two or more supporting members may be equiangularly spaced about the first axis. The two or more supporting members may, when viewed projected onto the plane perpendicular to the first axis, be spread to subtend an angle of less than or equal to 45° about the first axis. The two or more supporting members may, when viewed projected onto the plane perpendicular to the first axis, be spread to subtend an angle of less than or equal to 30° about the first axis. The two or more supporting members may, when viewed projected onto the plane perpendicular to the first axis, be spread to subtend an angle of less than or equal to 20° about the first axis.

The flow deflecting member may include, or take the form of, a blocking member disposed within the fluid conduit and held in place by a mesh. The blocking member may have the same thickness as the mesh in the direction parallel to the first axis. The blocking member may have a larger thickness than the mesh in the direction parallel to the first axis. The mesh may cover the entire cross-section of the flow conduit. The mesh may cover a fraction of the cross-section of the flow conduit, for example a strip. The blocking member may be attached to the mesh. The blocking member may be integrally formed with the mesh. The blocking member may correspond to a region of the mesh in which through-holes of the mesh are wholly or partly filled in.

The mesh may be attached or bonded to an interior surface of the flow conduit. The mesh may be attached or bonded to an insert received within the flow conduit. The mesh may be received through a slot in the flow conduit and may be removable. The mesh may be received over the first and/or second openings of the flow conduit and sandwiched between the flow conduit and incoming and/or outgoing pipes.

A thickness of the mesh parallel to the first axis may be less than a dimension of through-holes of the mesh. A thickness of the mesh parallel to the first axis may be less than or equal to half the dimension of through-holes of the mesh. The mesh may be a wire-mesh. When viewed projected onto the plane perpendicular to the first axis, the projected area of the mesh structure may be less than or equal to 20% of the projected area of through holes in the mesh (excluding the projected area of the blocking member.

When viewed projected onto the plane perpendicular to the first axis, the projection of the blocking member may be substantially oval, elliptical or circular. Substantially oval, elliptical or circular may mean that the projection of the blocking member is oval, elliptical or circular except where it meets the projection of the supporting member. Substantially oval, elliptical or circular may include the respective precise shapes.

A length of the blocking member along the first axis may be between 0.2 and 2 times a maximum dimension of the blocking member perpendicular to the first axis. The length of the flow deflecting member along the first axis may be between 0.5 and 0.7 times the maximum dimension of the flow conduit perpendicular to the first axis.

The flow deflecting member may not include any portions which are conical, frustoconical, pyramidal, or frustopyramidal. The blocking member may not include any portions which are conical, frustoconical, pyramidal, or frustopyramidal. The supporting member may not include any portions which are conical, frustoconical, pyramidal, or frustopyramidal.

The flow deflecting member may be configured such that swirl is not introduced in response to a straight fluid flow passing the flow deflecting member.

A pressure drop across the flow deflecting member may be 0.15 Pa or less in response to an average flow velocity in the flow conduit of 0.15 m·s⁻¹ of fluid in the form of water at 20° C.

One or more portions of the measurement region which are outside of any of the two or more beam paths may comprise non-sampled volumes. The ultrasonic meter may also include two or more protrusions extending along the first axis. At least part of each protrusion may be arranged to exclude fluid from at least part of one or more non-sampled volumes. The two or more protrusions may be arranged so that, for each beam path, a component transverse to the first axis passes through at least one space defined by a pair of protrusions.

The two or more protrusions may be integrally formed with the flow conduit. Alternatively, an insert may be secured within the flow conduit, and the insert may at least partly define a through passage comprising at least one of the two or more protrusions.

When viewed projected onto the plane perpendicular to the first axis, a projection of at least one support member may at least partly overlap with a projection of a protrusion of the two or more protrusions. The projection of the at least one support member may be aligned with the projection of a protrusion.

When viewed projected onto the plane perpendicular to the first axis, a projection of at least one support member may be aligned with a projection of at least one space defined by a pair of protrusions. The projection of the at least one support member may be aligned with a projection of at least one beam path.

At least one beam path may include at least one reflection. The reflection is not a 180 degree reflection.

The first flow deflecting member may be a first flow deflecting member. When viewed projected onto the plane perpendicular to the first axis, a projection of a third beam path may intersect a projection of a fourth beam path. The ultrasonic meter may also include a second flow deflecting member supported between the first opening and the measurement region. When viewed projected onto the plane perpendicular to the first axis, a projection of the second flow deflecting member may at least partially overlap the intersection of the projections of the third and fourth beam paths.

Either of the third beam path or the fourth beam path may be the first beam path. In other words, there may be a beam path in common between the intersections. Equally, there may be no beam paths in common between the intersections.

The second flow deflecting member may be substantially the same as the first flow deflecting member. The second flow deflecting member may include features corresponding to any features of the (first) flow deflecting member described herein.

For each flow deflecting member supported between the first opening and the measurement region, the ultrasonic meter may also include an identical flow deflecting member supported between the second opening and the measurement region.

When viewed projected onto the plane perpendicular to the first axis, a projection of each flow deflecting member supported between the first opening and the measurement region may entirely coincide with a projection of the corresponding flow deflecting member supported between the second opening and the measurement region. Each flow deflecting member supported between the second opening and the measurement region may be a reflection of the corresponding flow deflecting member supported between the first opening and the measurement region, about a mirror plane perpendicular to the first axis. However, such a mirror plane does not need to coincide with a midpoint of the measurement region.

According to a second aspect of the invention, there is provided an insert for an ultrasonic meter. The ultrasonic meter includes a flow conduit for the fluid. The flow conduit extending along a first axis between a first opening and a second opening. The ultrasonic meter also includes two or more pairs of ultrasonic transducers. Each pair of ultrasonic transducers is configured to define a corresponding beam path intersecting the flow conduit within a measurement region of the flow conduit. Substantially every part of each beam path makes a non-zero angle with the first axis. When viewed projected onto a plane perpendicular to the first axis, a projection of a first beam path intersects a projection of a second beam path. The insert includes a flow deflecting member configured such that, when the insert is received into the flow conduit, the flow deflecting member is supported between the first opening and the measurement region, and when viewed projected onto the plane perpendicular to the first axis, a projection of the flow deflecting member at least partially overlaps the intersection of the projections of the first and second beam paths.

The insert according to the second aspect may include features corresponding to any features of the ultrasonic meter according to the first aspect and/or may be configured for use with any ultrasonic meter according to the first aspect. Definitions applicable to the ultrasonic meter according to the first aspect may be equally applicable to the insert according to the second aspect.

According to a third aspect of the invention, there is provided an ultrasonic meter for measuring a flow-rate of a fluid, including a flow conduit for the fluid. The flow conduit extending along a first axis between a first opening and a second opening. The ultrasonic meter also includes one or more pairs of ultrasonic transducers. Each pair of ultrasonic transducers is configured to define a corresponding beam path intersecting the flow conduit within a measurement region of the flow conduit. Substantially every part of each beam path makes a non-zero angle with the first axis. When viewed projected onto a plane perpendicular to the first axis, a projection of a first beam path intersects a peak flow region. The ultrasonic meter also includes a flow deflecting member supported between the first opening and the measurement region. When viewed projected onto the plane perpendicular to the first axis, a projection of the flow deflecting member at least partially overlaps the intersection of the first beam path and the peak flow region. The peak flow region is defined relative to a projection onto the plane of a flow conduit of a reference ultrasonic meter which is identical to the ultrasonic meter except for omitting the flow deflecting member. The peak flow region corresponds to a region of the plane in which a flow velocity through the reference ultrasonic meter is above a mean flow velocity in response to passing a steady state fluid flow through the reference ultrasonic meter at a Reynolds number of approximately 3000.

The projected area of the reference meter is identical in shape and orientation to that of the ultrasonic meter. In other words, the peak flow region is defined relative to the flow profile which would result if the flow deflecting member were removed. A steady state fluid flow corresponds to the flow that would be found in a long straight pipe having a cross section corresponding to the projected area of the flow conduit. In other words, sufficiently far (e.g. at least ten times longer than a maximum dimension perpendicular to the first axis) from any disturbances resulting from bends, variations in cross sectional area, shape, and so forth. A Reynolds number of approximately 3000 may mean within ±10%, or within ±5%. Reynolds number may be determined from theory, simulations (e.g. finite element analysis) and/or experiments.

Instead of the peak flow region corresponding to flow velocities greater than or equal to the average flow velocity in the reference ultrasonic meter, the peak flow region may instead be defined to correspond to higher flow velocities. For example, if the average flow velocity in the reference ultrasonic meter is U_{avg} and the maximum is Uₘₐₓ, the peak flow region may be defined to correspond to flow velocities greater than or equal to U_{avg}+f(Uₘₐₓ−U_{avg}) with f equal to 0.1, 0.2, 0.25, 0.3, 0.4, 0.5, 0.6, 0.7, 0.75, 0.8, or 0.9

Flow velocity profiles in the reference ultrasonic meter in response to steady state fluid flow through the reference ultrasonic meter at a Reynolds number of approximately 3000 may be determined from theory, simulations (e.g. finite element analysis) and/or experiments.

Alternatively, the peak flow region may be approximately defined without consideration of fluid flows through the reference ultrasonic meter. For example, the peak flow region may be defined as a region which:
is concentric with the projection of the flow conduit;
is circular, or has the same shape and orientation as the projection of the flow conduit; and
has one quarter or less of an area of the projection of the flow conduit.

When viewed projected onto the plane perpendicular to the first axis, at least half the projected area of the flow deflecting member may overlap the peak flow region.

When viewed projected onto the plane perpendicular to the first axis, the result of subtracting the projection of the flow deflecting member from the projection of the flow conduit may be a continuously connected second region.

When viewed projected onto the plane perpendicular to the first axis, the result of subtracting the projection of the flow deflecting member from the projection of the flow conduit may be two or more separate regions including a primary region. An area of the primary region in the projection may account for 75% or more of the total projected areas of the two or more separate regions. The area of the primary region in the projection may account for 80% or more of the total projected areas of the two or more separate regions. The area of the primary region in the projection may account for 85% or more of the total projected areas of the two or more separate regions. The area of the primary region in the projection may account for 90% or more of the total projected areas of the two or more separate regions. The area of the primary region in the projection may account for 95% or more of the total projected areas of the two or more separate regions.

The ultrasonic meter according to the third aspect may include features corresponding to any features of the ultrasonic meter according to the first aspect. Definitions applicable to the ultrasonic meter according to the first aspect may be equally applicable to the ultrasonic meter according to the third aspect.

According to a fourth aspect of the invention, there is provided an insert for an ultrasonic meter. The ultrasonic meter including a flow conduit for the fluid. The flow conduit extends along a first axis between a first opening and a second opening. The ultrasonic meter also includes one or more pairs of ultrasonic transducers. Each pair of ultrasonic transducers is configured to define a corresponding beam path intersecting the flow conduit within a measurement region of the flow conduit. Substantially every part of each beam path makes a non-zero angle with the first axis. When viewed projected onto a plane perpendicular to the first axis, a projection of a first beam path intersects a peak flow region. The peak flow region is defined relative to a projection onto the plane of a flow conduit of a reference ultrasonic meter which is identical to the ultrasonic meter except for omitting the flow deflecting member. The peak flow region corresponding to a region of the plane in which a flow velocity through the reference ultrasonic meter is above a mean flow velocity in response to passing a steady state fluid flow through the reference ultrasonic meter at a Reynolds number of approximately 3000. The insert includes a flow deflecting member configured such that, when the insert is received into the flow conduit, the flow deflecting member is supported between the first opening and the measurement region, and when viewed projected onto the plane perpendicular to the first axis, a projection of the flow deflecting member at least partially overlaps the intersection of the first beam path and the peak flow region.

The insert according to the fourth aspect may include features corresponding to any features of the ultrasonic meter according to the first and/or third aspects, and/or may be configured for use with any ultrasonic meter according to the first and/or third aspects. Definitions applicable to the ultrasonic meter according to the first aspect and/or the third aspect may be equally applicable to the insert according to the fourth aspect.

According to a fifth aspect of the invention, there is provided an insert for an ultrasonic meter. The ultrasonic meter including a flow conduit for the fluid. The flow conduit extends along a first axis between a first opening and a second opening. The insert is configured to be received within the flow conduit. The insert includes a flow passage for fluid having the same shape as the flow conduit and extending along the first axis. The insert also includes a flow deflecting member. When viewed projected onto a plane perpendicular to the first axis, a projection of a peak flow region is concentric with a projection of the flow passage, has the same shape and orientation as the projection of the flow passage, and has less than or equal to a quarter of the area of the projection of the flow passage. When viewed projected onto a plane perpendicular to the first axis, a projection of the flow deflecting member at least partially overlaps the peak flow region.

When viewed projected onto a plane perpendicular to the first axis, the projection of the flow deflecting member may correspond to the projection of the peak flow region.

The insert according to the fifth aspect may include features corresponding to any features of the ultrasonic meter according to the first and/or third aspects, and/or may be configured for use with any ultrasonic meter according to the first and/or third aspects. Definitions applicable to the ultrasonic meter according to the first aspect and/or the third aspect may be equally applicable to the insert according to the fifth aspect.

According to a sixth aspect of the invention there is provided use of the ultrasonic meter according to the first aspect, the insert according to the second aspect, the ultrasonic meter according to the third aspect, the insert according to the fourth aspect, or the insert according to the fifth aspect, for metering flow of a fluid. The fluid may be water. The fluid may be natural gas.

### BRIEF DESCRIPTION OF THE DRAWINGS

Certain embodiments of the present invention will now be described, by way of example, with reference to the accompanying drawings in which:

FIG. 1 is a schematic cross-section of a first ultrasonic meter;

FIG. 2 is a schematic cross-section of a second ultrasonic meter;

FIG. 3 is a schematic end-on view of a dual-beam ultrasonic meter;

FIG. 4 is a schematic, cut-away projection view of the dual-beam ultrasonic meter shown in FIG. 3;

FIG. 5 is a schematic end-on view of a tri-beam ultrasonic meter;

FIG. 6 illustrates an ultrasonic meter installed in a setter;

FIGS. 7A and 7B present calculated flow-speed profiles respectively just before and just after a sharp bend;

FIG. 8A is a schematic end-on view which illustrates a flow conditioning device

FIG. 8B is a schematic end-on view which illustrates a geometry used for comparative calculations of pressure drops;

FIG. 9 is a schematic cross-section which illustrates the effects of a flow conditioning device;

FIG. 10 is a schematic end-on view of a second dual-beam ultrasonic meter;

FIG. 11 is a schematic cross-section of the second dual-beam ultrasonic meter;

FIG. 12A presents a calculated flow-speed profile immediately following a flow deflecting member positioned in a straight pipe;

FIG. 12B presents a calculated flow-speed profile immediately following a flow deflecting member positioned after a sharp bend in a pipe;

FIG. 13 presents % errors measured for an ultrasonic meter including a flow deflecting member;

FIG. 14 is a schematic cross-section of a flow deflecting member;

FIG. 15A is a schematic end-on view of the flow deflecting member shown in FIG. 14;

FIGS. 15B and 15C are alternative cross-sections corresponding to the line labelled A-A* in FIG. 15A;

FIG. 16A is a schematic cross-section of a second flow deflecting member;

FIGS. 16B and 16C are cross-sections corresponding respectively to lines labelled B-B* and C-C* in FIG. 16A;

FIG. 17 is a schematic cross-section of a third flow deflecting member;

FIG. 18 is a schematic cross-section of a fourth flow deflecting member;

FIGS. 19A to 19F illustrate an annular insert providing a flow deflecting member;

FIGS. 20A and 20B illustrate a second annular insert providing a flow deflecting member;

FIG. 21 schematically illustrates a first beam configuration;

FIG. 22 schematically illustrates a second beam configuration

FIG. 23 schematically illustrates a third beam configuration

FIG. 24 schematically illustrates a fourth beam configuration

FIG. 25A schematically illustrates a fifth beam configuration;

FIG. 25B is a schematic end-on view of flow deflecting members used with the fifth beam configuration shown in FIG. 25A;

FIG. 26 schematically illustrates a peak flow region of a flow conduit having a circular cross-section;

FIG. 27 schematically illustrates a peak flow region of a flow conduit having a square cross-section;

FIG. 28 schematically illustrates a peak flow region of a flow conduit having a rectangular cross-section;

FIG. 29 is a schematic cross-section of a first combined ultrasonic meter;

FIG. 30 is a schematic cross-section of a second combined ultrasonic meter;

FIG. 31 is a schematic end-on view which illustrates an exemplary configuration of protrusions for an ultrasonic meter;

FIG. 32 is a schematic end-on view illustrating the positioning a flow deflecting member relative to the protrusions of the exemplary configuration shown in FIG. 31;

FIG. 33 is a schematic end-on view of a single-beam ultrasonic meter;

FIG. 34 is a schematic, cut-away projection view of the dual-beam ultrasonic meter shown in FIG. 33;

FIG. 35 is an schematic end-on view of a flow deflecting member in which a through-hole is formed in a supporting member;

FIG. 36 is an schematic end-on view of a flow deflecting member in which a supporting member has a differently shaped through-hole to that shown in FIG. 35;

FIG. 37A is a schematic cross-section of a first alternative configuration of a flow deflecting member, FIG. 37B is a schematic end-on view of the first alternative configuration of a flow deflecting member;

FIG. 38A is a schematic cross-section of a second alternative configuration of a flow deflecting member, FIG. 38B is a schematic end-on view of the second alternative configuration of a flow deflecting member;

FIG. 39 is an schematic end-on view of a flow deflecting member having a blocking member held in place by three supporting members;

FIGS. 40A is a schematic cross-section of a flow deflecting member having a blocking member held in place by a mesh, and FIG. 40B is a schematic end-on view of the flow deflecting member having a blocking member held in place by a mesh.

### DETAILED DESCRIPTION OF CERTAIN EMBODIMENTS

In the following, like parts are denoted by like reference numbers.

Whilst the protrusions detailed in WO 2019/229409 A1 can provide an ultrasonic meter with substantial immunity from flow-profile variations arising from the deployed location, further improvements in flow-profile immunity may be obtained using flow deflecting members described herein. This may be particularly useful for fluid meters which need to be installed in the vicinity of significant sections of curvature in supply and/or onward pipes, for example, in water-meter setters. The flow deflecting members described herein may be used in combination with protrusions described in WO 2019/229409 A1 for particularly high-tolerance applications. Equally, flow deflecting members described herein may be used without protrusions described in WO 2019/229409 A1 and may still provide improved flow-profile immunity.

The term “flow-profile immunity” herein refers to the sensitivity of an ultrasonic meter to differences between a steady state flow-speed profile (e.g. in a long, straight pipe) and the flow-speed profile in use, which may include transients and deviations from the steady state profile.

Similarly to the protrusions detailed in WO 2019/229409 A1, and by way of contrast to conventional flow conditioners, flow-deflecting members disclosed herein do not attempt to accelerate or force fluid flow to match a particular assumed flow-speed profile. Instead, the flow-deflecting members described herein operate according to a principle of deflecting fluid flows away from a particular region or regions of a fluid conduit, at least as the fluid flows through the measurement beams of an ultrasonic meter.

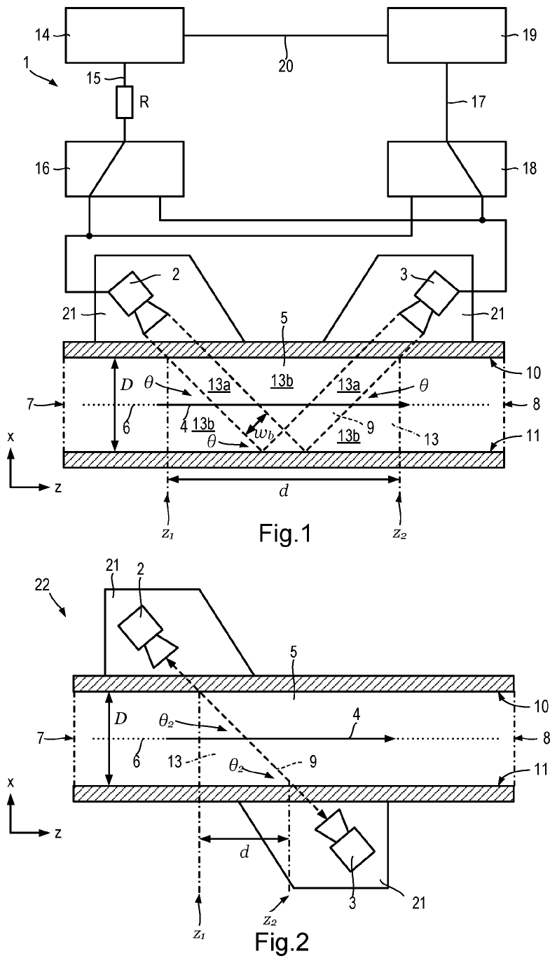

Referring to FIG. 1, an ultrasonic meter 1 for measuring a flow-rate of a fluid is shown.

The ultrasonic meter 1 is useful for understanding the present invention. The ultrasonic meter 1 includes a first ultrasonic transducer 2 and a second ultrasonic transducer 3. The first and second ultrasonic transducers 2, 3 are spaced apart along a fluid flow path 4 in the form of a flow conduit 5. The flow conduit 5 extends along a first axis 6 (z-axis in the FIG. 1 example) between a first opening 7 and a second opening 8. The term “flow conduit” encompasses both the volume for fluid flow and also the structure or structures defining that volume. For example, a flow conduit 5 may often take the form of a pipe which encloses a pipe bore through which fluid may flow. However, the flow conduit 5 is not limited to pipes, and may take the form of any structure or structures capable of containing a fluid flow path 4. The first and second transducers 2, 3 are configured to define a beam path 9 between the first and second ultrasonic transducers 2, 3 and having a component in a direction parallel to the first axis 6. In other words, substantially every part of the beam path 9 makes a non-zero angle with the first axis 6.

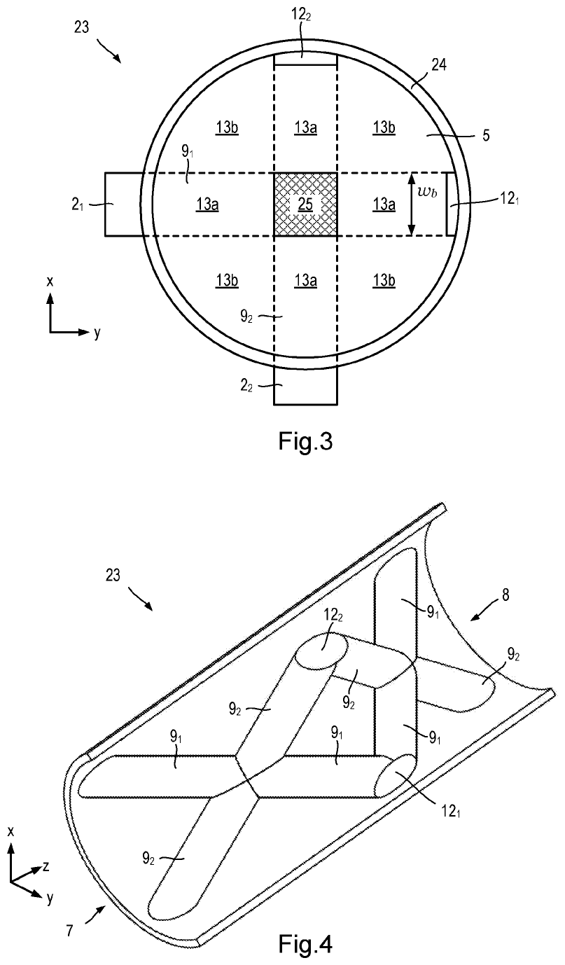

In the example shown in FIG. 1, the first and second ultrasonic transducers 2, 3 are offset from the fluid flow path 4 formed by the flow conduit 5 and oriented at angles ±θ to the first axis 6. Both ultrasonic transducers 2, 3 are arranged spaced apart along the first axis 6 and on a first side 10 of the flow conduit 5. The beam path 9 includes a reflection from a second side 11 of the flow conduit 5, opposed to the first side 10. The flow conduit 5 may include a separate reflector 12 (FIG. 3), or the second side 11 of the flow conduit 5 may be integrally formed to function as a suitable reflector for the beam path 9. The ultrasonic transducers 2, 3 may be piezoelectric transducers, solenoid transducers, and so forth.

The beam path 9 has a finite cross-sectional area, and in general the cross-sectional shape of the beam path 9 will be related to the shapes of the first and second transducers 2, 3. However, an effective area of the beam path 9 will typically represent a fraction of the total transducer 2, 3 area, because the power of the emitted ultrasound may be focussed towards the centre of the transducer 2, 3. The relative sensitivity of a transducer 2, 3 used as a receiver is similarly greater towards the centre. Typically, the emitted power/sensitivity varies continuously across a face of a transducer 2, 3. Beam path 9 effective width w_{b} (or other appropriate dimension) may be defined as the width w_{b} over which the emitted power/sensitivity remains above a threshold value, for example half of maximum. For example, the transducers 2, 3 may be circular and the beam path 9 may have an effective diameter w_{b} which is greater than or equal to ⅓ of a diameter of the transducers 2, 3 and less than or equal to said diameter of the transducers 2, 3. In another example the transducers 2, 3 may be square or rectangular, and the beam path 9 may have a square or rectangular cross-section with side length(s) w_{b} which is (are) greater than or equal to ⅓ of corresponding side lengths of the transducers 2, 3 and less than or equal to said side lengths of the transducers 2, 3. Hereinafter, the effective beam path 9 width w_{b} (or other dimension) will be referred to rather than the transducer 2, 3 dimensions, because the effective beam path 9 width w_{b} is more closely related to the volume of fluid which is sampled.

The beam path 9 intersects the flow conduit 5 within a measurement region 13 of the flow conduit. The measurement region 13 is the part of the flow conduit 5 which is sampled by the beam path 9. The measurement region 13 spans between a first position z₁ and a second position z₂ spaced apart along the first axis 6, and has a length along the flow path 4 of d=z₂−z₁. Portions of the measurement region 13 which intersect the effective width w_{b} (or other dimension) of one or more beam paths 9 may be referred to hereinafter as sampled volumes 13a of the measurement region 13. Portions of the measurement region which are outside the effective width w_{b} (or other dimension) of any of the beam paths 9 shall be referred to hereinafter as non-sampled volumes 13b of the measurement region 13. As discussed hereinafter, non-sampled volumes 13b of the measurement region 13 do not contribute to determining a calculated flow speed u.

The flow conduit 5 typically has a circular cross-section in a plane perpendicular to the first axis 6, but may have other shapes such as square, rectangular, elliptical and so forth. Typically, though not essentially, the cross-sectional shape and/or area of the flow conduit 5 will be matched to pipes/conduits which supply fluid through the first opening 7 and into which the fluid flows through the second opening (or the reverse). In ultrasonic meter 1, the flow conduit 5 is cylindrical with diameter D, for example the flow conduit 5 may take the form of a cylindrical pipe. The flow path 4 in FIG. 1 illustrates a fluid flow path 4 from the first opening 7 to the second opening 8. In other examples, the flow path 4 may be directed from the second opening 8 to the first opening 7 instead.

The ultrasonic meter 1 also Ies a controller 14, which is configured to drive the first and second ultrasonic transducers 2, 3 alternately. In order to make a measurement of flow rate, the controller 14 may drive the first ultrasonic transducer 2 and measure a first time-of-flight t₁ based on reception of the signal at the second ultrasonic transducer 3. The controller 14 then measures a second time of flight t₂ by driving the second ultrasonic transducer 3 and receiving the signal at the first ultrasonic transducer 2. If the fluid in the flow conduit 5, which may be a gas or a liquid, is moving from the first opening 7 towards the second opening 8 with a velocity, u, which is typically substantially directed along the first axis 6 then the total velocity of the sound v₁ when measuring the first time of flight t₁ will be:

$${v}_{1} = c + u \qquad ( 1 )$$

In which c is the velocity of sound in the fluid if the fluid was stationary (and directed along the beam path). Similarly, the total velocity v₂ when measuring the second time of flight t₂ will be:

$${v}_{2} = c - u \qquad ( 2 )$$

The transit times between the first ultrasonic transducer 2 and the measurement region 13 and between the second ultrasonic transducer 3 and the measurement region 13 are constant, and consequently the difference Δt=t₂−t₁ depends on the average velocity u in the flow conduit 5. In this way, the controller 14 may determine the average speed u in the direction of the first axis 6 in the flow conduit 5, and hence estimate a flow rate by assuming the flow is all parallel to the first axis 6. In practice, the ultrasonic meter 1 may be calibrated using at least one, and preferably more, known flow rates of fluid passing through the flow conduit 5.

However, it should be noted that the calculated flow speed u is an average across the fluid which passes through the beam path 9. Any fluid which does not pass through the beam path 9 does not contribute to the measurement of the average speed u. In other words, fluid passing through at least one sampled volume 13a will contribute to the measurement of the average speed u, whereas fluid which only passes through non-sampled volumes 13b does not contribute to the measurement of the average speed u.

The controller 14 outputs a drive signal 15 to a transmitting ultrasonic transducer 2, 3 via an impedance matching resistor R and a first switch or multiplexer 16. The first switch 16 may be controlled to supply the drive signal 15 to either the first ultrasonic transducer 2 or the second ultrasonic transducer 3. Whichever ultrasonic transducer 2, 3 receives the drive signal 15 is the transmitting ultrasonic transducer for a measurement. The drive signal 15 may include a pulsed or square waveform having variable frequency, duty cycle and so forth.

Whichever ultrasonic transducer 2, 3 does not receive the drive signal 15 is the receiving ultrasonic transducer for a measurement. The receiving ultrasonic transducer 2, 3 detects an ultrasound signal from the transmitting ultrasonic transducer 2, 3, and converts it into a received electrical signal 17. The received signal 17 is returned to the controller 14 via a second switch or multiplexer 18 and a signal conditioning circuit 19. The first and second switches 16, 18 are configured so that when, for example, the first switch 16 connects to the first ultrasonic transducer 2, the second switch 18 will connect to the second ultrasonic transducer 3, and vice-versa. The signal conditioning circuit 19 may perform amplification and/or filtering of the received signal 17 to generate a conditioned signal 20. The controller 14 is configured to determine the times-of-flight t₁, t₂. Determination of the first and second times-of-flight t₁, t₂ may be carried out using a variety of methods. For example, the controller 14 may determine the times-of-flight t₁, t₂ by comparing the drive signal 15 with the conditioned signal 20. Alternatively, the controller 14 may determine the times-of-flight t₁, t₂ by measuring a time between the start of the drive signal 15 and a reference point on the conditioned signal 20 such as, for example, reaching a certain signal amplitude or the m^{th} zero of the oscillation with m a positive integer (i.e. counting m periods).

The controller 14 may be a microcontroller, a microprocessor, or any other suitable data processing apparatus configurable to perform the described functions. In some examples, the controller 14, the signal conditioning circuit 19, and the first and second switches 16, 18 may all be integrated into a single integrated circuit (for example an application specific integrated circuit, ASIC) in order to simplify the electronics of the ultrasonic meter 1.

The first and second ultrasonic transducers 2, 3 may be external to the flow conduit 5, as shown in FIG. 1. In such a configuration, first and second ultrasonic transducers 2, 3 may be connected to the flow conduit 5 using impedance matching materials 21 to enhance transmission of ultrasound in and/or out of the flow conduit 5. Alternatively, the first and/or second ultrasonic transducers 2, 3 may be embedded within, or integrally formed as part of, a wall defining the flow conduit 5. In other examples, the first and/or second ultrasonic transducers 2 may be located within the flow conduit 5.

Referring also to FIG. 2, a second ultrasonic meter 22 useful for understanding the present invention is shown. Only the centroid of the beam path 9 is shown in FIG. 2 for clarity of the illustration.

The second ultrasonic meter 22 is similar to the first ultrasonic meter 1, except that the second ultrasonic transducer 3 is arranged on the second side 11 of the flow conduit 5, such that the beam path 5 does not include a reflection, and such that tan(θ₂)=D/d.

As described hereinbefore, ultrasonic meters 1, 22 measure an average fluid speed u which depends only on the fluid which intersects the beam path 9. Any fluid which passes through the respective measurement region 13 without passing across the beam path 9 at least once (i.e. passes only through non-sampled volumes 13b) does not affect the measurement. Including a reflection in the beam path 9, as in the first ultrasonic meter 1, may extend the length of the beam path 9 compared to the second ultrasonic meter 22. However, some fluid will still not intersect the beam path 9. Consequently, in the first and second ultrasonic meters 1, 22, only a fraction of the actual fluid flow, that which passes through sampled volumes 13a, is measured. Any measurement of an average fluid speed u then inherently includes assumptions about the flow-speed profile through the meter 1, 22.

Conversion of the measured average speed u into a mass flow rate of the fluid relies upon an assumed speed u across the flow conduit 5 and known cross sectional area. At minimum, it must be presumed that the sampling of the fluid by the beam path is representative, which may often prove an inaccurate assumption. For example, in high volume applications, for example metering of irrigation or industrial water, even small % errors may lead to significant over- or under-estimation of water use.

The exemplary assumed flow speed profile of a cylindrical flow conduit 5 may be described by the empirical equation:

$$u ( y ) = {{u}^{*} ( \frac{y}{r} )}^{\frac{1}{n}} \qquad ( 3 )$$

In which y is the distance from the first/second side 10, 11, perpendicular to the first axis 6, u(y) is the local flow speed at position y, u* is the average flow speed measured by the ultrasonic meter 1, 22, r is the radius of the cylindrical flow conduit 5 and n is an empirically derived exponent. For an example of this form of assumed flow speed profile 22, the reader is referred to FIG. 3 of WO 2019/229409 A1, which plots relative speed u(y)/u* on the vertical axis against relative distance across the flow conduit y/r for a value of n=10.

The value of the exponent n will depend on various properties of the ultrasonic meter 1, 22 and fluid including, but not limited, to the flow rate, temperature, fluid viscosity and the geometry of the ultrasonic meter 1, 22.

A variety of techniques exist for correcting for an assumed flow-speed profile in an ultrasonic meter 1, 22. One option is to empirically, theoretically or computationally determine a correction factor to apply to the flow rate. Another option is to position the ultrasonic beams 9 in such a way that when they are added together they remain constant and independent of the flow profile.

However, any deviation of the actual local flow speeds from the assumed local flow speeds u(y) will introduce errors into the estimate of the mass flow of fluid passing the ultrasonic meter 1, 22. When an ultrasonic meter 1, 22 is installed in, or directly downstream of, a long, straight section of pipe, an actual flow speed profile may be relatively close to an assumed flow speed profile determined from empirical measurements and/or modelling using fluid dynamics. However, proximity of bends, valves, pumps, constrictions and so forth either upstream or downstream of an ultrasonic meter 1, 22 will cause the actual flow speed profile to differ from an assumed flow speed profile, reducing accuracy of the ultrasonic meter 1, 22. Such disturbances are difficult to predict and may also vary depending on the flow rate, temperature and so forth. In practical installations, there may not be a sufficiently long, straight section of piping in which to install an ultrasonic meter 1, 22 to ensure accurate measurements. This is particularly the case when an ultrasonic meter is to be installed in a water meter setter, for example, to replace a mechanical meter.

In ultrasonic meters which include multiple beam paths 9, there are additional sources of potential calibration error.

Referring also to FIGS. 3 and 4, beam paths 9₁, 9₂ are illustrated for a dual-beam ultrasonic meter 23.

The dual beam ultrasonic meter 23 has a cylindrical flow conduit 5 defined by a cylindrical pipe 24. The dual beam ultrasonic meter 23 includes a pair of beam paths 9₁, 9₂ defined between respective pairs of first 2₁, 2₂ and second 3₁, 3₂ ultrasonic transducers. The first beam path 9₁ is effectively the same as the beam path 9 of the first ultrasonic meter 1, and the second beam path 9₂ is identical except that it is rotated by 90° about the first axis 6 (corresponding to the z direction as illustrated). Substantially every part of both beam paths 9₁, 9₂ makes a non-zero angle with the first axis 6. In other words, this specification is not concerned with ultrasonic meters in which a measurement is primarily made using a beam running parallel to a flow direction through a flow conduit 5.

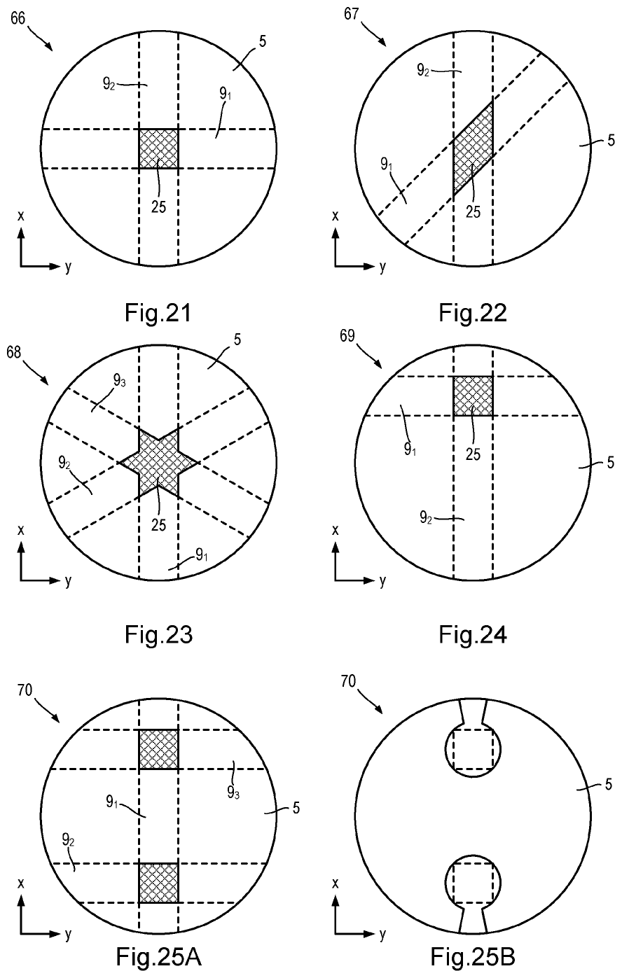

Referring in particular to FIG. 4, the beam paths 9₁, 9₂ intersect at two points through the measurement region. Fluid which flows through the volumes of intersection between the beam paths 9₁, 9₂ is sampled twice. An ultrasonic meter such as the dual beam ultrasonic meter 23 may be particularly sensitive to deviations from an assumed flow-speed profile which occur in double (triple, etc) sampled regions. As discussed hereinafter in relation to FIG. 21, fluid flows may be double or tripled sampled etc even if the volumes of the beam paths 9 do not actually intersect in 3D space.

Indeed, referring in particular to FIG. 3, the inventors have found that it is sufficient to consider the projections of the flow conduit 5 and beam paths 9₁, 9₂ onto a plane perpendicular to the first axis 6. In the illustration of FIG. 3, the first axis 6 is parallel to the z direction as drawn, so the projection plane corresponds to the x-y plane. A projected intersection 25 on the projection plane (x-y) is defined as the intersection between a projection of the first beam path 9₁ and a projection of the second beam path 9₂. Although flow through the flow conduit 5 will not in practice be completely parallel to the first axis 6, in almost all practical circumstances, flow velocities through an ultrasonic meter 1, 22, 23 will generally have the largest component parallel to the first axis 6. Consequently, in the absence of being re-directed/deflected, fluid flowing through a portion of the first opening 7 corresponding to the projected intersection 25 is most likely to pass through both the first and second beam paths 9₁, 9₂.

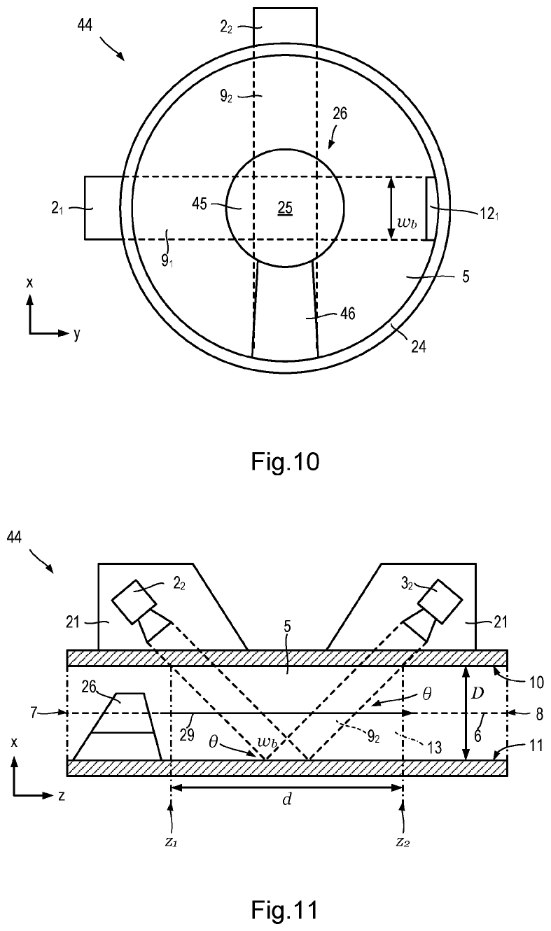

As explained further in relation to FIG. 10, the inventors have found that sensitivity to disturbances of an incident flow-speed profile from a steady state condition may be reduced by intentionally introducing a significant disturbance in the form of a flow deflecting member 26 (FIG. 10) supported between the first opening 7 and the start of the measurement region 13 (position z1). In particular, when viewed projected onto the plane (x-y) perpendicular to the first axis 6, a projection/projected area of the flow deflecting member 26 (FIG. 10) at least partially overlaps the projected intersection 25 between the first 9₁ and second 9₂ beam paths. Whilst seemingly counter-intuitive, the introduction of a controlled disturbance which deflects fluid flow away from a relatively sensitive volume may reduce a degree of difference in measurements in response to a deviation between incident flow-speed profiles during calibration and when installed, improving accuracy.

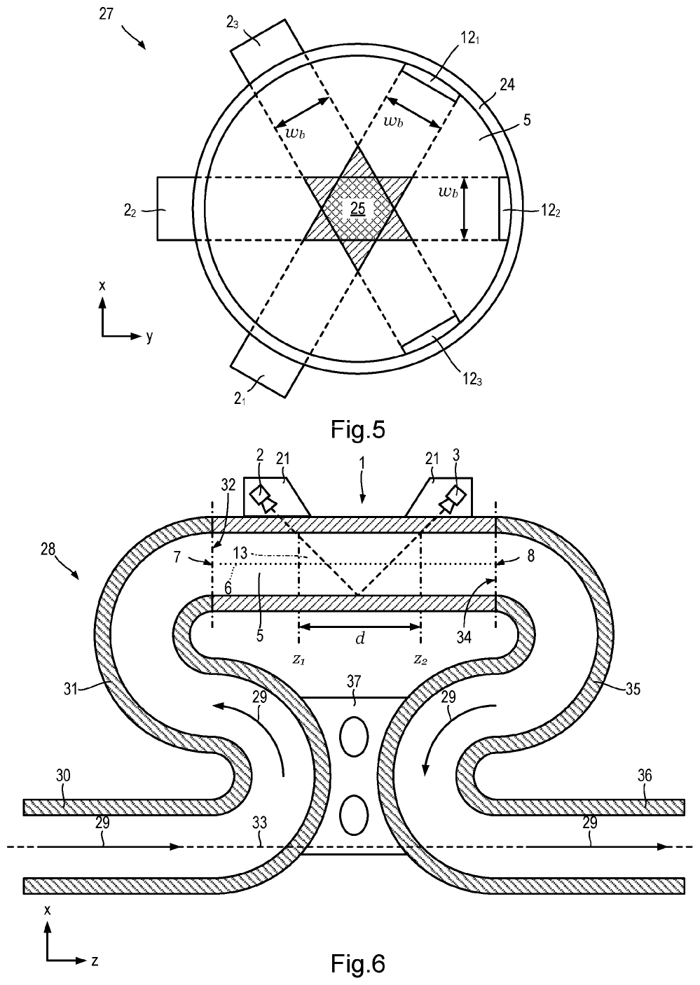

Referring also to FIG. 5, a tri-beam ultrasonic meter 27 is shown.

The tri-beam ultrasonic meter 27 is the same as the dual-beam ultrasonic meter 23, except that it includes three beam paths 9₁, 9₂, 9₃ defined between respective pairs of first 2₁, 2₂, 2₃ and second 3₁, 3₂, 3₃ ultrasonic transducers. The beam paths 9₁, 9₂, 9₃ all have the same shape, the second beam path 9₂ is rotated by 60° clockwise from the first beam path 9₁, and the third beam path 9₃ is rotated by 60° clockwise from the second beam path 9₂.

When projected onto a plane (x-y) perpendicular to the first axis 6, there are multiple regions where the projections of beam paths 9₁, 9₂, 9₃ intersect. In a central, hexagonal shaped region (cross-hatched shading), all three beam paths 9₁, 9₂, 9₃ intersect, whilst surrounding triangular regions (diagonal shading) correspond to intersections of a pair of the beam paths 9₁, 9₂, 9₃. For the purposes of this specification, unless explicitly stated otherwise, the projected intersection 25 corresponds to the union of all such adjacent regions. In other words, the projected intersection 25 for the tri-beam ultrasonic meter 27 has the shape of a six-pointed star. A pair of projected intersections 25 will be considered to be separate where there is not overlap between them (see FIG. 25A).

Before discussing the flow deflecting member 26 (FIG. 10) in further detail, it shall be helpful to briefly discuss the reasons why the flow speed profiles through ultrasonic meters often deviate in use from steady state conditions typically used during calibration.

Referring also to FIG. 6, a first ultrasonic meter 1 is shown installed in a “setter” 28.

A setter 28 is a structure commonly found in water meter installations, although the same or similar structures may be found in systems for delivering other fluids such as gases. A fluid flow path 29 enters the setter 28 through a first straight pipe section 30, then enters a first serpentine section 31 which serves to re-direct flow to a first setter opening 32 which is generally parallel to, but offset from, an axis 33 of the first straight pipe 30. The first setter opening 32 is opposed across a gap by a second setter opening 34 leading into a second serpentine section 35 which re-directs flow to a second straight pipe section 36 running parallel to the original axis 33. In the example shown in FIG. 6, the setter openings 32, 34 are offset upwards relative to the illustrated y-axis. In practice, such configurations are often used to bring fluid flow in a buried pipe closer to the surface to facilitate the installation, servicing, replacement and/or reading of a fluid flow meter.

In the example shown in FIG. 6, the second serpentine section 35 is the mirror image of the first serpentine section 31, and this is often the case for setters 28. However, in principle there is no reason why the serpentine sections 31, 35 need to be mirror images of one another. The configuration that each serpentine section 31, 35 bends back on itself is commonly used to minimise the size (or “footprint”) of the setter 28. For example, such that the entire setter 28 may be contained in as small a hole as possible when included in an underground pipe.

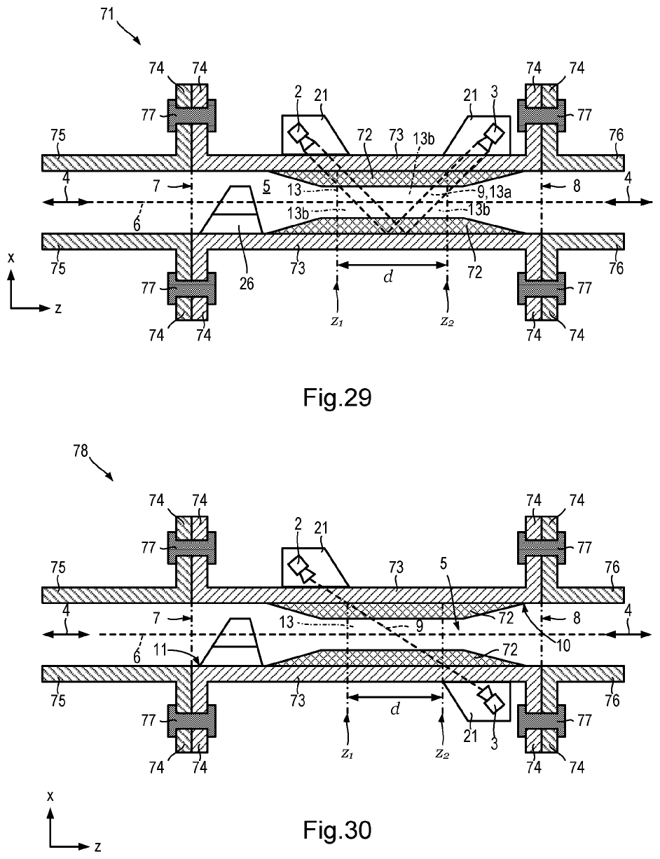

It is also not essential that the second straight pipe section 36 be parallel and/or oriented in the same direction as the first straight pipe section 30. In other words, the setter 28 may be disposed at a point where a fluid pipeline changes direction and/or position. The first and second straight pipe sections 30, 36 may be connected to fluid pipelines (not shown) extending away from the setter 28, for example, using bolted flange connections (see FIGS. 29 and 30). Alternatively, the first and second straight pipe sections 30, 36 may be omitted, and the serpentine sections 31, 35 may connect directly to a fluid pipeline which is being metered.

An ultrasonic meter 1 is received between the first 32 and second 34 setter openings, and secured in place using, for example, bolted flanges (not shown in FIG. 6, see FIGS. 29 and 30). Although the first ultrasonic meter 1 is shown in FIG. 6, any ultrasonic meter described hereinbefore or hereinafter may be used instead.

The first and second serpentine sections 31, 35 are often connected by one or more support members 37 which serve to maintain relative positions and alignments of the first and second setter openings 32, 34 when no ultrasonic meter is installed.

As the fluid flow path 29 enter the first straight pipe section 30, it may have an approximately steady state flow-speed profile, for example as described by Equation (3) and illustrated in FIG. 3 of Wo 2019/229409 A1.

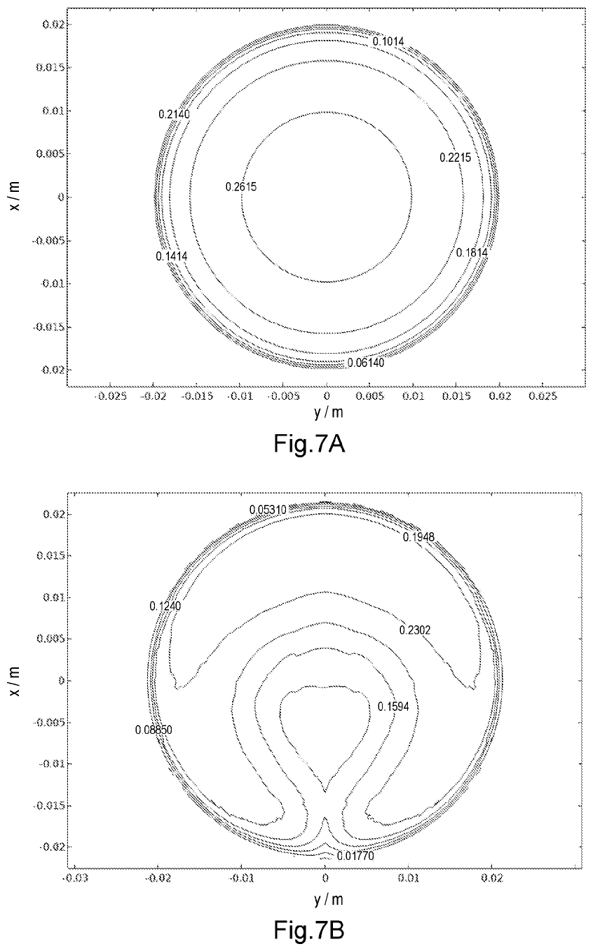

For example, referring also to FIG. 7A, a contour plot of a modelled steady state flow-speed profile is shown for a cylindrical pipe.

The modelling was finite-element analysis (FEA) modelling conducted using the COMSOL Multiphysics (RTM) software package (version 5.6.0.341). The pipe was modelled for flow of a fluid 29 in the form of water at 293.15 K, and the cylindrical piper had an internal diameter of 4 cm. The flow rate was 1 m³·hr⁻¹. Selected contours are labelled with the corresponding speed in m·s⁻¹. The speeds shown are the components of a calculated velocity field v(x,y,z) along the first axis 6, i.e. v(x,y,z).e_{z}, with e_{z} a unit vector along the first axis 6. It may be observed that the flow speed profile matches expectations for steady state flow down a pipe with no-slip boundary conditions.

However, once fluid flows through the first serpentine section 31, the flow-speed profile is significantly disturbed.

For example, referring also to FIG. 7B, a contour plot of a modelled steady state flow speed profile is shown for a cylindrical pipe immediately after a 90° bend.

The modelling used the same parameters and total flow rate as the model shown in FIG. 7A, all that was changed was to change the cylindrical pipe from straight to bent.

It may be observed that the flow speed profile is substantially skewed towards an outer side of the bend, which in this example corresponds to the positive x-axis direction (with the z-axis directed into the page).

Since ultrasonic meters 1, 22, 23, 27 are calibrated based on known flow rates having flow-speed profiles approximating the steady state case of FIG. 7A, the disturbances introduced from a bend or similar, as shown in FIG. 7B, may lead to inaccuracies in measurements of flow speed u of as much as 10%. In addition, the actual deviation (relative to steady state) of a flow-speed profile at a given installation location depends on the details of that installation location, which in general is not known in advance. For example, there may be a setter 28 or similar arrangement, or there may be no setter 28. Even if you knew that a setter 28 would be used, these can vary widely in terms of shape and so forth.

In the context of chemical plants or manufacturing processes, accurate knowledge of how much fluid has flowed/is flowing along a flow conduit 5 may be important for process efficiency, process control and/or safety. In an economic context, if an ultrasonic flow meter 1, 22, 23, 27 is used to meter a quantity of fluid supplied from a provider to a consumer, measurement errors will cause the consumer to be overcharged or the provider to be underpaid. Therefore, as discussed elsewhere herein, there has been interest in improving the accuracy of ultrasonic meters 1, 22, 23, 27.

One approach has been to add further pairs of ultrasonic transducers 2, 3 in order to define additional beam paths 9 and increase a fraction of the fluid which is sampled. In other words, in order to increase the relative fraction of sampled volumes 13a compared to non-sampled volumes 13b. However, adding further pairs of ultrasonic transducers 2, 3 increases the cost and complexity of an ultrasonic meter 1, 22, 23, 27, and there will always be some residual non-sampled volumes 13b within the measurement region 13, which are not sampled by any beam path 9. Additionally, as explained hereinbefore in relation to FIGS. 3 to 5, sampling the same volume of the measurement region 13 two or more times may actually amplify errors resulting from a flow-speed profile through such multi-sampled volumes deviating from an assumed and calibrated profile.

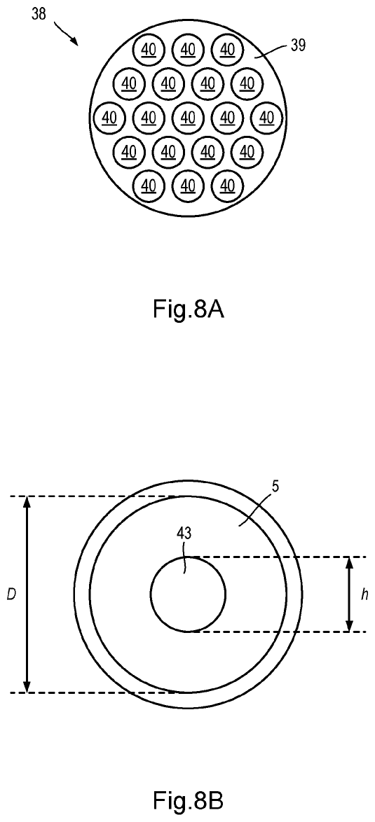

Another approach to improving the accuracy of an ultrasonic meter 1, 22, 23, 27 has been to install one of more flow conditioning devices 38 (FIG. 8A) upstream and/or downstream of an ultrasonic meter 1, 22, 23, 27. Flow conditioning devices 38 (FIG. 8A) are used to force the flow speed profile into a known flow speed profile matching that used for calibration of an ultrasonic meter.

Referring also to FIG. 8A, an example of a flow conditioning device 38 is shown.

The exemplary flow conditioning device 38 includes a cylindrical body 39 dimensioned to fit across a cylindrical flow conduit 5, and including a number of through-holes 40 which permit flow of the fluid.

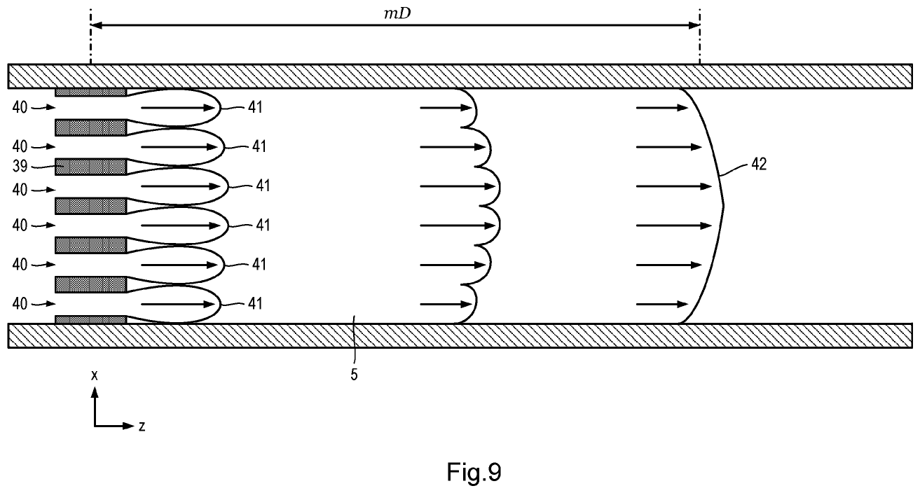

Referring also to FIG. 9, flow of a fluid through, and downstream of, the exemplary flow conditioning device 38 is illustrated.

As the fluid 29 is forced through the flow conditioning device 38, a jet 41 emerges from each through-hole 40. As the fluid continues to flow along the flow conduit 5, the jets 41 gradually merge. A distance m·D after the flow conditioning device 38, in which m is a scalar multiplier m>0, the fluid 29 develops a stable, steady state flow-speed profile 42. The multiplier m is usually a factor of about four or five, i.e. a distance of four or five times the diameter D of a cylindrical flow conduit 5. An ultrasonic flow meter 1, 22, 23, 27 cannot be placed too close to such a conventional flow conditioning device 38, since the intention is to obtain the steady state flow speed profile 42, which requires a distance from the flow conditioning device 38. For example, if the ultrasonic meter 1, 22, 23, 27 is placed at least m·D away from the flow conditioning device 38, a repeatable flow speed profile may be obtained.

The flow conditioning device 38 shown in FIGS. 8A and 9 is only one example, and a wide range of different structures are available, though all operate according to similar principles based on forcing flow-speed profiles to return more quickly to a steady state distribution.

Although flow conditioning devices allow greater flexibility in the locations for installing an ultrasonic meter 1, 22, 23, 27, a straight section of sufficient length to permit development of a steady state flow speed profile 42 is still required. Additionally, as a flow conditioning device 38 is required to effectively reset the flow speed profile, significant impacts on the flow are unavoidable, and pressure drops across flow conditioning devices may be substantial. For example, from FEA modelling using the same parameters as the data shown in FIGS. 7A and 7B, and a flow conditioning device including 17 holes of diameter 5 mm each, a pressure drop of 549 Pa was calculated.

Flow conditioning devices 38 may also increase the complexity of installing an ultrasonic meter 1, 22, 23, 27, as two devices are installed at two different locations, or else the flow conditioning device must be inserted and secured some distance from a pipe opening. Some applications have requirements which may prevent the use of many common flow conditioning devices 38. For example, in fluids which include entrained solid matter (a good example being irrigation water containing plant matter), a flow conditioning device 38 as shown in FIGS. 8A and 9 may be susceptible to clogging.

This pressure drop associated with a conventional flow conditioning device 38 may be contrasted with pressure drops corresponding to simpler obstructions.

Referring also to FIG. 8B, a schematic geometry used for FEA modelling of pressure drops is shown.

FEA modelling used the same parameters described hereinbefore. The flow conduit 5 was a cylindrical pipe with internal diameter D=40 mm. A cylindrical obstruction 43 with diameter h was modelled positioned concentrically with the cylindrical pipe and extending for a distance 23 mm along the first axis 6. Pressure drops across the cylindrical obstruction 43 were calculated for three different ratios h/D of obstruction 43 to flow conduit 5 diameters:

| h/D | Pressure drop/Pa |
|---|---|
| 0.25 | 10.73 |
| 0.5 | 25.53 |
| 0.75 | 137.68 |

It may be observed that, for modest ratios h/D, the pressure drop due to an obstruction is predicted to be less than that associated with a conventional flow conditioning device 38.

The present specification concerns the inventors realisation that ultrasonic meters and/or inserts for ultrasonic meters may be produced which reduce sensitivity to variations in the incident flow-speed profile of fluids, based on the targeted placement of an obstruction upstream of the measurement region 13. Ultrasonic meters and/or inserts according to the present specification may increase the range of locations in which an ultrasonic meter may be installed whilst providing accurate measurements. Ultrasonic meters and/or inserts according to the present specification may be combined with protrusions and other features described in WO 2019/229409 A1, so as to further reduce the sensitivity to variations in an incident flow-speed profile of measured fluids.

In contrast to conventional approaches such as conditioning the flow to provide a repeatable and reliable steady state flow-speed profile, the present specification does not try to control the flow-speed profile to a fully developed steady state flow as a prior art flow conditioner would. Instead, the present specification describes using one or more flow deflecting members which are arranged to deflect fluid 29 flow away from corresponding projected intersections 25, where an ultrasonic meter may be particularly sensitive to variability in an incident flow-speed profile (as compared to a steady state calibration condition). In this way, the present invention does not rely on an assumed flow-speed profile. Consequently, the sensitivity of an ultrasonic meter to disturbances caused by corners, valves, constrictions, pumps and so forth may be reduced.

### Ultrasonic Meter Including a Flow Deflecting Member

Referring also to FIGS. 10 and 11, a second dual beam ultrasonic meter 44 is shown.

FIG. 10 shows a projection onto a plane perpendicular to the first axis 6, and FIG. 11 shows a schematic cross section along the centre of the second dual beam ultrasonic meter 44.

The second dual beam ultrasonic meter 44 includes a flow conduit 5 for the fluid 29. The flow conduit 5 extends along the first axis 6 between a first opening 7 and a second opening 8. In the example of the second dual beam ultrasonic meter 44, the flow conduit 5 is a cylindrical flow conduit having internal diameter D. However, this shape is not essential, and an ultrasonic meter according the present invention may include a flow conduit 5 having any shape permitting through-flow of fluid. Whilst the flow conduit 5 preferably has a constant cross-section and area (perpendicular to the first axis 6), at least through a majority of the measurement region 13, this is not essential.

The second dual beam ultrasonic meter 44 includes two pairs of ultrasonic transducers 2₁, 2₂, 3₁, 3₂, each pair defining a corresponding beam path 9₁, 9₂ intersecting the flow conduit 5 within a measurement region 13 of the flow conduit 5. The beam paths 9₁, 9₂ of the second dual beam ultrasonic meter 44 are V-shaped with one reflection each (as illustrated in FIG. 1), so that substantially every part of either beam path 9₁, 9₂ makes a non-zero angle θ with the first axis 6. The first and second beam paths 9₁, 9₂ are rotated 90° from one another about the first axis 6. When viewed projected onto a plane perpendicular to the first axis 6 (an x-y plane as illustrated, for example corresponding to the first opening 7), a projection of a first beam path 9₁ intersects a projection of a second beam path 9₂ to define a projected intersection 25. In the second dual beam ultrasonic meter 44, the projected intersection 25 is square, with a projected area of the beam width w_{b} squared w_{b}².

A flow deflecting member 26 is supported between the first opening 7 and the measurement region 13. When viewed projected onto the plane (x-y) perpendicular to the first axis 6 (as in FIG. 10), a projection of the flow deflecting member 26 overlaps the intersection 25 of the projections of the first 9₁ and second 9₂ beam paths.

The second dual-beam ultrasonic meter 44 is essentially the same as the dual-beam ultrasonic meter 23, except for the addition of the flow deflecting member 26. The flow deflecting member 26 acts to deflect fluid 29 flows which would be sampled by both the first beam path 9₁ and the second beam path 9₂ (double sampled).

In this way, when the second dual-beam ultrasonic meter 44 is calibrated, the action of the flow deflecting member prevents excessive sensitivity to fluid flowing through the projected intersection, by deflecting flow away from multiply-sampled volumes (see FIG. 4). Consequently, the second dual-beam ultrasonic meter 44 may be less sensitive to variations in an incident flow-speed profile.

The second dual-beam ultrasonic meter 44 is a specific example, but in the general case a flow deflecting member 26 may be employed in any ultrasonic meter for measuring a flow-rate of a fluid which includes a flow conduit 5 extending along a first axis 6 between a first opening 7 and a second opening 8, and having two or more pairs of ultrasonic transducers 2, 3. Each pair of ultrasonic transducers 2, 3 is configured to define a corresponding beam path 9 intersecting the flow conduit 5 within a measurement region 13 of the flow conduit 5, substantially every part of each beam path 9 makes a non-zero angle with the first axis 9. The beam paths 9 are not restricted to 90° angular separations about the first axis 6, as shown for the second dual-beam ultrasonic meter 44, and may be configured in any way provided that substantially every part of each beam path 9 makes a non-zero angle with the first axis 9. In general, there is not any requirement for beam paths 9 to be related to one another by rotational symmetry about the first axis 6. In the general case, when viewed projected onto a plane perpendicular to the first axis 6, a projection of at least a first beam path 9₁ should intersect at least a projection of a second beam path 9₂. Multiple projected intersections 25 may be present, and each may be associated with a corresponding flow deflecting member 26 (see for example FIGS. 25A and 25B).

In the general case, at least one flow deflecting member 26 is supported between the first opening 7 and the measurement region 13, and when viewed projected onto the plane perpendicular to the first axis 6, a projection of the flow deflecting member 26 should at least partially overlap the intersection 25 of the projections of the first 9₁ and second 9₂ beam paths.

When it is stated herein that substantially every part of each beam path 9 makes a non-zero angle with the first axis 6, this may mean that 75% or more of a length along the beam path 9 corresponds to parts which make a non-zero angle with the first axis 6. Preferably, every part of each beam path, i.e. the entire length, makes a non-zero angle with the first axis 6, as in the V-shaped beam paths shown of the. When a part of a beam path 9 is said to make a non-zero angle with the first axis 6, that non-zero angle may be between 10 degrees and 80 degrees (inclusive of end-points). Another way to consider this is that each beam path 9 should preferably be configured so that within the measurement region 13, the intersection of that beam path with the measurement region 13 includes a component parallel to the first axis 6 and a component transverse to the first axis 6.

In the second dual-beam ultrasonic meter 44, the flow deflecting member includes a blocking member 45 disposed within the fluid conduit 5 and held in place by a supporting member 46. This configuration is preferred, although in other examples there may be multiple supporting members.

Preferably, the blocking member 45 and the supporting member 46 are integrally formed. However, it is possible to form a flow deflecting member using a blocking member 45 and a supporting member 46 in the form of separate structures which are bonded, welded or otherwise attached to one another. When viewed projected onto the plane perpendicular to the first axis 6, a projection of the blocking member 45 should at least partially overlap the intersection 25 between projections of the first 9₁ and second 9₂ beam paths.

The flow deflecting member 26, including the blocking member 45 and supporting member 46 when present, may be formed from polymeric materials, metals (which will not excessively corrode in the fluid 29 to be measured), composite materials, or any other materials suitable for forming rigid and mechanically robust structures. Examples of suitable materials include polyphenylene sulfide (PPS), high density polyethylene (HDPE), polyoxymethylene composites (POMC), for example glass fibre reinforced/filled. Examples of metals include stainless steel, coated cast iron, copper and so forth.

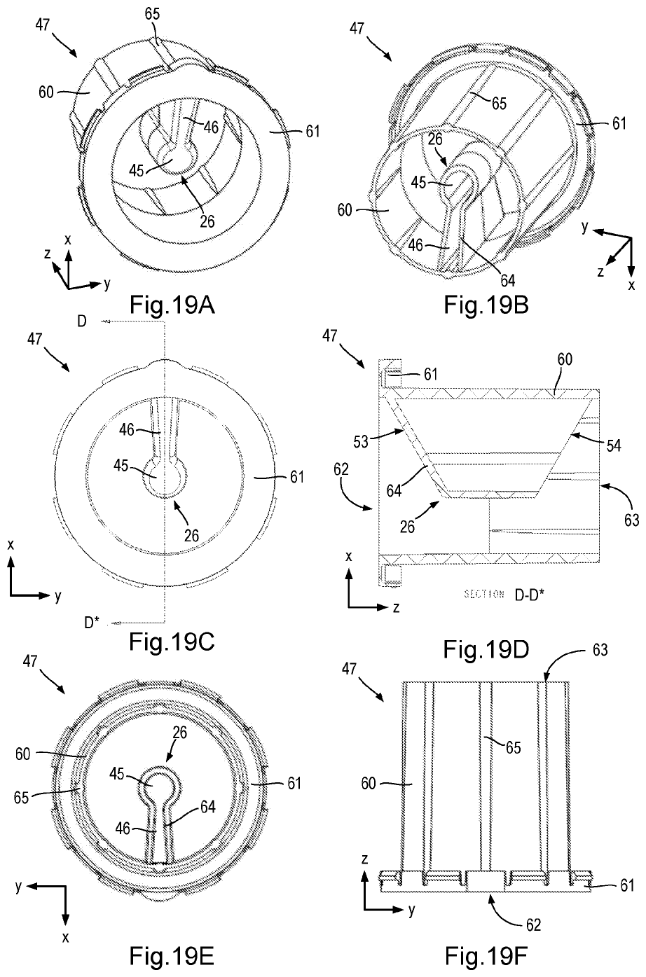

As illustrated in FIGS. 10 and 11, the supporting member 46 serves to connect the blocking member 45 to an interior surface of the fluid conduit 5. However, in some examples the supporting member 46 may instead connect the blocking member 45 to an annular insert 47 (FIGS. 19A to 19F) received within the fluid conduit 5. Provision of the flow deflecting member 26 using an annular insert 47 has advantages for maintenance, cleaning and/or replacement of the flow deflecting member 26.

When viewed projected onto a plane perpendicular to the first axis 6 (x-y as illustrated), a projection of the supporting member 46 connects to a projection of the blocking member 45 along a connection direction (parallel to the y-axis in FIG. 10), and a maximum dimension of the projection of the blocking member 45 perpendicular (along the x-axis as illustrated) to the connection direction y is greater than a maximum dimension of the projection of the supporting member 46 perpendicular to the connection direction y. This is preferred to minimise a pressure drop across the flow deflecting member 26, however, in other examples there may be no meaningful distinction between a blocking member 45 and a supporting member 46.

When viewed projected onto the plane perpendicular to the first axis 6, the projection of the blocking member 45 may be substantially circular as shown in FIG. 10. However, in other examples, the projection of the blocking member 45 may be oval or elliptical in shape, or indeed any other suitable shape, for example, the projection of the blocking member 45 may be shaped to match a shape of a corresponding projected intersection 25 of beam paths 9. When a projection of a blocking member 45 is described as substantially oval, elliptical or circular, this refers to said projection of the blocking member 45 being oval, elliptical or circular except where it meets the projection of the supporting member 46.

The purpose of the flow deflecting member 26 is to intentionally disrupt fluid flows, and as such, the flow deflecting member 26 should not include any portions which are conical, frustoconical, pyramidal, frustopyramidal and so forth. This applies to both the blocking member 45 and the supporting member 46, when present. Additionally, the flow deflecting member should be configured such that swirl is not introduced in response to a straight fluid flow passing the flow deflecting member 26. This is because it is preferable for the measurement of fluid speed for fluid to follow paths through the measurement region 13 which, as far as possible, lie parallel to the first axis 6.

The pressure drop across a flow deflecting member 26 should preferably be no more than 0.15 Pa with an average flow velocity in the conduit of 0.15 m/s with 20° C. water. Pressure drops may be measured experimentally, or may be calculated theoretically, for example using FEA simulations. The pressure drop may be managed primarily by varying the dimensions of the blocking member 45.

For example, starting from the geometry and parameters explained in relation to FIG. 8B, the pressure drop for a cylindrical blocking member 45 of diameter h=12 mm and length 23 mm, and held in position by a supporting member 46 of width 7 mm and length 34 mm, the pressure drop across the flow deflecting member calculated from FEA modelling was 10.66 Pa.

When viewed projected onto the plane perpendicular to the first axis 6 (e.g. x-y plane in FIG. 10), the projection of the flow deflecting member 26 should not divide a projection of the flow conduit 5 into two separate regions. This may help to avoid catching/trapping of entrained particles and/or fibres on the flow deflecting member 26. Compared to, for example, the flow conditioning device 38, this can make the flow deflecting member 26 less susceptible to clogging. This may be particularly useful when the fluid is, for example, waste-water or irrigation water, which may include natural and/or human produced detritus.

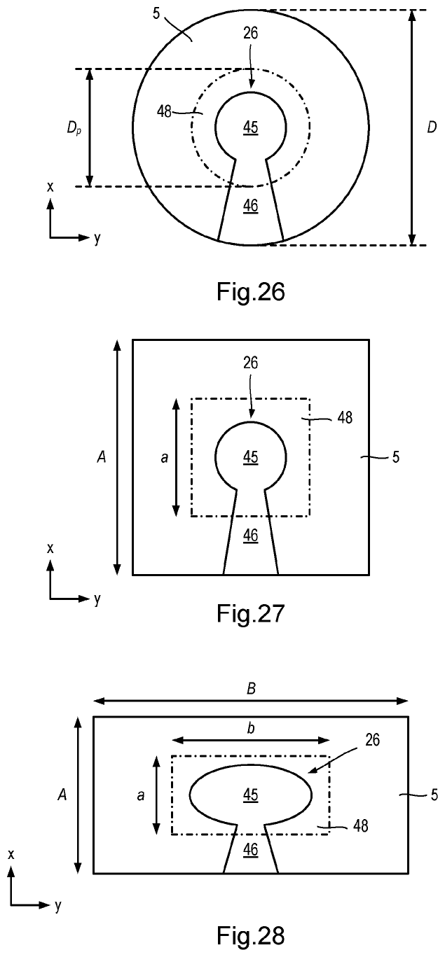

The effectiveness of the flow deflecting member 26 may be further increased if, in addition to at least partially overlapping a projected beam intersection, the flow deflecting member 26 also at least partially overlaps the projection of a peak flow volume 48 onto the plane perpendicular to the first axis 6. The peak flow volume 48 corresponds to the volume through which a flow speed through a reference ultrasonic meter would be above a mean flow speed in response to passing a steady state fluid flow through the reference ultrasonic meter at a Reynolds number of approximately 3000. The reference ultrasonic meter in a given case corresponds to an ultrasonic meter which is identical except for omission of any flow deflecting members 26. The peak flow volume 48 and related parameters are discussed in further detail with reference to FIGS. 26 to 28 hereinafter.

### Effect of the Flow Deflecting Member

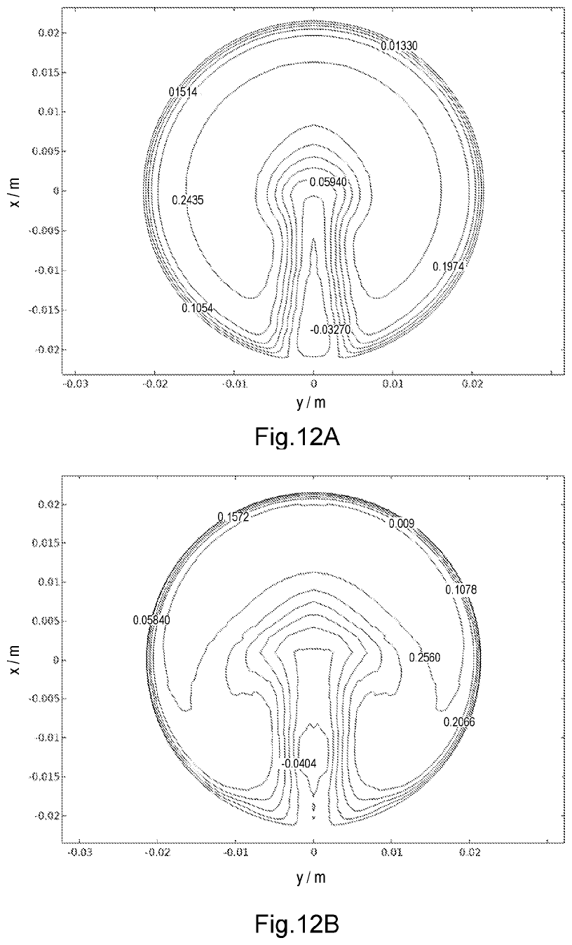

Referring also to FIG. 12A, FEA simulation results are shown corresponding to FIG. 7A, except that a flow deflecting member 26 was added to the model, having a blocking member 45 of diameter h=12 mm and length 23 mm, and held in position by a supporting member 46 of width 7 mm and length 34 mm The flow speed profile is shown immediately downstream from the flow deflecting member 26.

Referring also to FIG. 12B, FEA simulation results are shown corresponding to FIG. 7B, with the inclusion of the same flow deflecting member 26 as for FIG. 7A.

Comparing FIGS. 12A and 12B with FIGS. 7A and 7B, it may be observed that the inclusion of the flow deflecting member 26 results in reduced influence of the bend on the flow speed profile, both qualitatively and quantitatively. In other words, the differences between FIGS. 12A and 12B are less pronounced that the differences between FIGS. 7A and 7B.

Since the flow-speed profiles of FIGS. 7A and 12A correspond to typical calibration conditions, it may be observed that an ultrasonic meter including the flow deflecting member 26 remains closer to the corresponding calibrated state that an ultrasonic meter without a the flow deflecting member 26, even when installed immediately after a sharp bend.

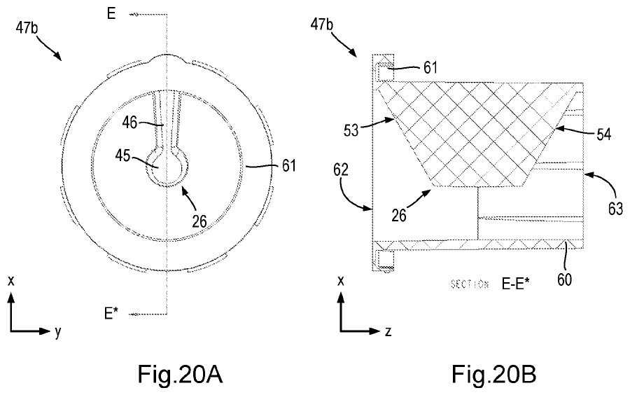

Referring also to FIG. 13, experimentally measured % errors for fluid flows emerging from a sharp bend are plotted as a function of total flow rates when using a flow deflecting member 26 positioned within 1 cm of the exit from a bend (first series 49—solid line), or when using a flow deflecting member 26 positioned within 1 cm of the measurement region (second series 50, dashed line). In both cases, the flow deflecting member 26 used was that of the second annular insert 47b shown in FIGS. 20A and 20B.

In may be observed that the % error was held within a range of −1.5% to 0.5% throughout, and across most flow rates when just before the measurement region 13, the % error was held between −1% and 0%.

### Flow Deflecting Member Shape

The following discussion of optional, specific features of flow deflecting member 26 is applicable to any flow deflecting members 26 described hereinbefore and/or hereinafter.

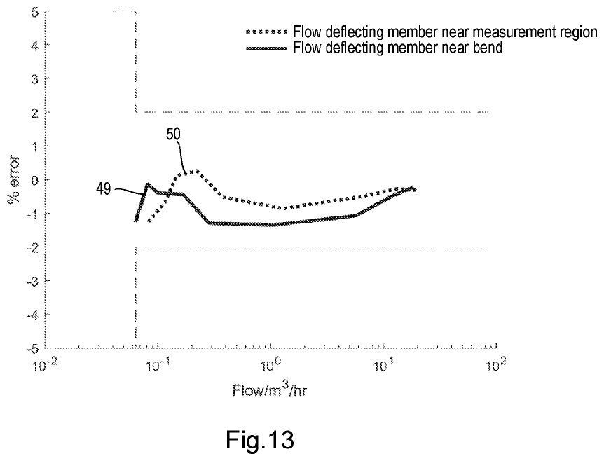

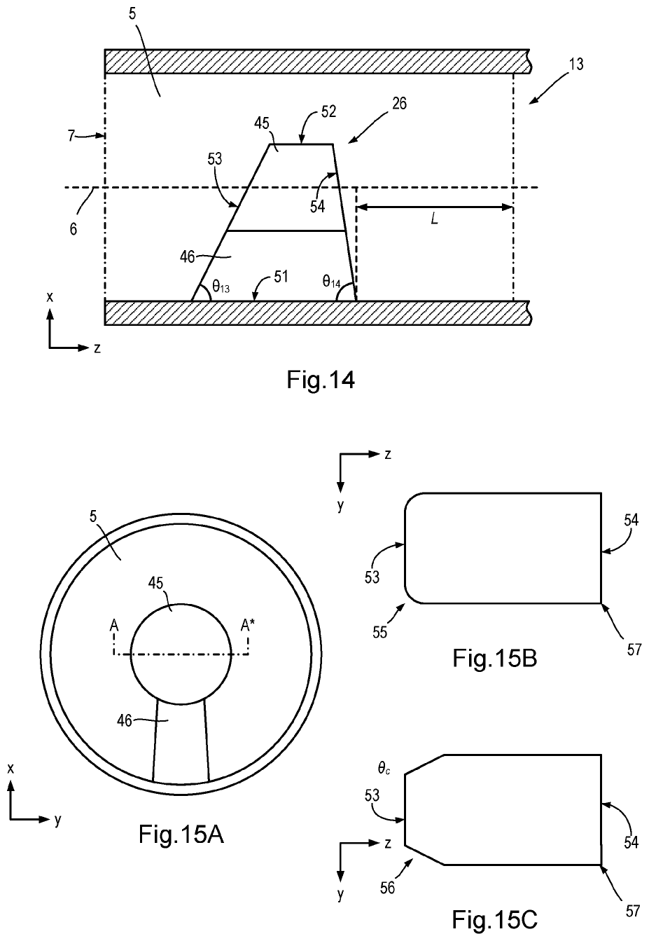

Referring also to FIG. 14, a flow deflecting member 26 including a blocking member 45 and a supporting member 46 is shown in a schematic cross section spanning between the first opening 7 and the start of the measurement region 13.

Referring also to FIG. 15A, is a view of the flow deflecting member 26 shown in FIG. 14, projected onto a plane perpendicular to the first axis 6.

Referring also to FIGS. 15B and 15C, examples of schematic cross-sections through the blocking member 45 along the line labelled A-A* in FIG. 15A are shown.

The flow deflecting member 26 is separated from the measurement region 13 by a distance L along the first axis which is between zero and five times a maximum dimension of the flow conduit 5 perpendicular to the first axis 6. In the example shown in FIG. 14, the flow conduit 5 is cylindrical within an interior diameter D, however, in a square or rectangular flow conduit, the maximum dimension may take the form of a diagonal. The separation distance L is shown between the start of the measurement region 13 and the supporting member 46, however, the distance L may alternatively be defined as a separation of the blocking member 45 from the measurement region 13.

When viewed projected onto a plane parallel to the first axis 6, the flow deflecting 26 member has a quadrilateral shape. In the example shown in FIG. 14, the plane parallel to the first axis 6 is an x-z plane, and is also parallel to a mirror plane of the flow deflecting member 26. In the example shown in FIG. 14, the quadrilateral shape is a trapezium. In general, the quadrilateral shape has a first side 51 parallel to the first axis 6 and disposed at or near an outer wall of the flow conduit 5, a second side 52 parallel to the first axis 6 and shorter than the first side 51, a third (or “leading”) side 53 facing towards the first opening 7 and making a first internal angle θ₁₉ to the first side 51, and a fourth (or “trailing”) side 54 facing towards the measurement region 13 and making a second internal angle θ₁₄ to the first side 51. In the example shown in FIG. 14, the first internal angle θ₁₉ is less than the second internal angle θ₁₄, θ₁₃<θ₁₄. However, in general the first θ₁₃ and second θ₁₄ angles may be equal, or may be different. The first angle θ₁₉ may range between 45 and 80 degrees (inclusive of endpoints), whilst the second angle θ₁₄ may range between 45 and 135 degrees (inclusive of endpoints). The range of the second angle θ₁₄ encompasses the quadrilateral shape taking the form of a parallelogram.

Referring in particular to FIG. 15B, the leading side 53 of the flow deflecting member 26 facing towards the first opening 7 may have a rounded bevel profile 55 around all, or at least part, of the perimeter of the leading side 53. The rounded bevel profile 55 may extend around the portion of the leading side 53 corresponding to the blocking member 45 and/or the portion of the leading side 53 corresponding to the supporting member 46. Instead of a rounded bevel profile 55, all or part of the leading side 53 may have a fillet, tapering or chamfered profile.

For example, referring in particular to FIG. 15C, the leading side 53 of the flow deflecting member 26 facing towards the first opening 7 may have a chamfer profile 56 making a chamfer angle Oc to the first axis 6.

In contrast to the first side 53, the trailing side 54 of the flow deflecting member 26 facing towards the measurement region 13 may have a sharp edge 57 around all, or at least part, of the perimeter of the trailing side 54. For example, the sharp edge 57 may correspond to a Kamm-tail profile. The sharp edge 57 may extend only around the portion of the trailing side 54 corresponding to the blocking member 45, whilst the portion of the trailing side 54 corresponding to the supporting member 46 may be configured for streamlining, for example using a rounded bevel profile, a fillet profile, a tapering profile or a chamfered profile.

A sharp edge 57 around at least the portion of the trailing side 54 corresponding to the blocking member 45 is preferred because this acts to prevent reconnecting streamlines downstream of the blocking member 45. The intention is to deflect flow away from the volume occluded (when viewed along the first axis 6) by the blocking member 45 of the flow deflecting member 26.

In practice, the sharp edge 57 may have some, small, radius of curvature. In some example, around all, or at least some, of the trailing side 54, the flow deflecting member may exhibit a rounded profile, for example a fillet or chamfer profile having a characteristic dimension smaller than that of a profile of a perimeter of the leading side 53. For example, a characteristic dimension of between 0 mm (or as close as possible in practice) and 0.25 times a dimension of the flow deflecting member 26 (alternatively the blocking member 45) perpendicular to the first axis 6.

In some examples, the projection of the flow deflecting member 26 onto a plane parallel to the first axis 6 (i.e. side view) need not be a quadrilateral.

A length of the blocking member 45 along the first axis 6 is preferably between 0.2 and 2 times a maximum dimension of the blocking member 45 perpendicular to the first axis 6. The length of the overall flow deflecting member 26 along the first axis 6 is preferably between 0.5 and 0.7 times a maximum dimension of the flow conduit 5 perpendicular to the first axis 6, for example the diameter D when the flow conduit 5 is cylindrical.

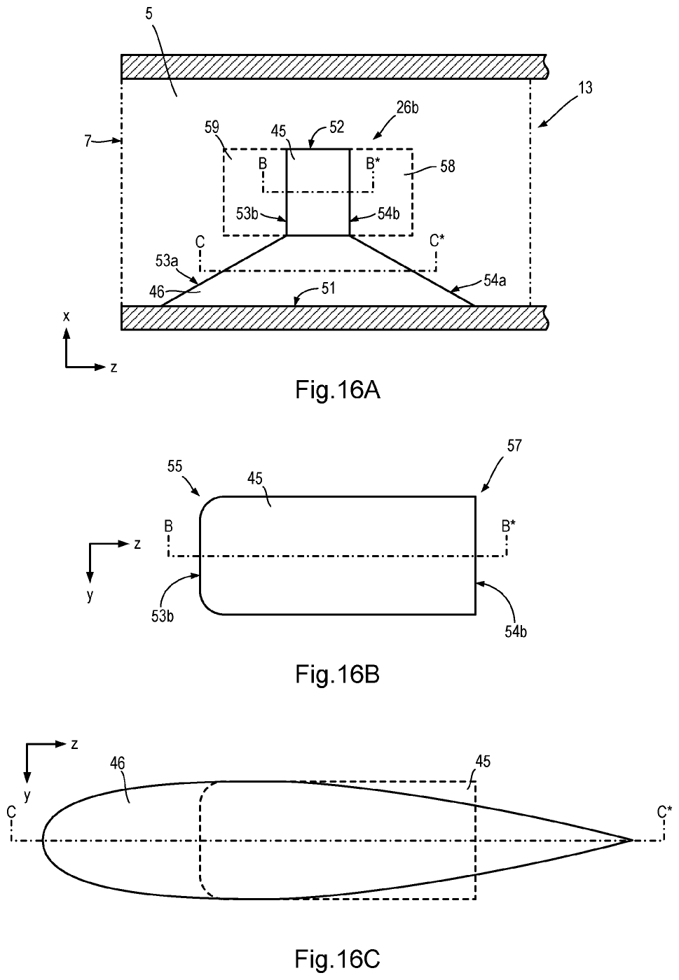

Referring also to FIGS. 16A to 16C, a second flow deflecting member 26b is shown. FIG. 16A shows a cross-section along a mirror plane (x-z) of the second flow deflecting member 26b. FIG. 16B shows a cross section along the line labelled B-B* in FIG. 16A, and FIG. 16C shows a cross section along the line labelled C-C* in FIG. 16A.

The leading side 53 of the second flow deflecting member 26b is divided into a first leading part 53a corresponding to the supporting member 46 and a second leading part 53b corresponding to the blocking member 45. When viewed projected onto a plane parallel to the first axis 6 (i.e. side view), the first leading part 53a makes an angle to the second leading part 53b. Similarly, the trailing side 54 of the second flow deflecting member 26b is divided into a first trailing part 54a corresponding to the supporting member 46 and a second trailing part 54b corresponding to the blocking member 45. When viewed projected onto a plane parallel to the first axis 6 (i.e. side view), the first trailing part 54a makes an angle to the second trailing part 54b. Thus, when viewed projected onto a plane parallel to the first axis 6 (i.e. side view), the second flow deflecting member 26b is an irregular hexagon.

Referring in particular to FIG. 16B, the exterior perimeter of the second leading part 53b (i.e. the perimeter except where it adjoins the first leading part 53a) may have a rounded bevel profile 55, or equivalently a fillet, chamfered or tapering profile, or any other profile described in relation to the leading side 53 of the flow deflecting member 26. Similarly, the exterior perimeter of the second trailing part 54b (i.e. the perimeter except where it adjoins the first trailing part 54a) preferably has a sharp edge 57, or any other profile described in relation to the trailing side 53 of the flow deflecting member 26. In other words, the leading and trailing sides of the blocking member 45 are configured in any way previously described for the blocking member 45 of the flow deflecting member 26.

In contrast to this, and referring in particular to FIG. 16C, the supporting member 46 has a teardrop-shaped profile, or other equivalently streamlined profile. The combination of the sharp edge 57 on the blocking member 45 with streamlining of the supporting member 46 allows maximising the disturbance of the blocking member 45 to re-direct fluid 29 flow away from multiply sampled volumes (corresponding to the projected intersection 25), whilst minimising the disturbance (and pressure drop) associated with the supporting member 46.

In FIG. 16A, the supporting member 46 is shown with a trapezium shape when viewed projected onto the plane parallel to the first axis 6 (i.e. side view), and the blocking member 45 extends upwards (positive y-direction as drawn) from the short side of the trapezium shape. However, in other examples, the blocking member 45 may include a trailing extension 58 overhanging the first trailing part 54a. Additionally or alternatively, the blocking member 45 may include a leading extension 59 overhanging the first leading part 53a.

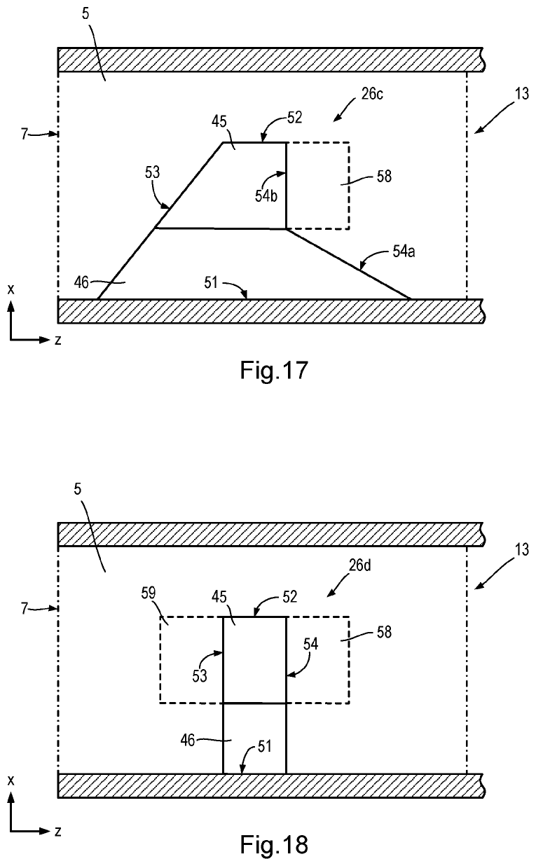

Referring also to FIG. 17, a third flow deflecting member 26c is shown, in a cross-section along a mirror plane (x-z) of the third flow deflecting member 26c.

When viewed projected onto a plane parallel to the first axis 6 (i.e. side view), the leading side 53 of the third flow deflecting member 26c is flush and parallel between the blocking member 45 and the supporting member 46, in the same way as the flow deflecting member 26 shown in FIGS. 14 to 15C. The trailing side 54 of the third flow deflecting member 26c is divided into first 54a and second 54b trailing parts which meet at an angle, in the same way as for the second flow deflecting member 26b. In this way, when viewed projected onto a plane parallel to the first axis 6 (i.e. side view), the third flow deflecting member 26c has the shape of an irregular pentagon.

All, or at least part, of the perimeter of the leading side 53 corresponding to the blocking member 45 may have any profile described hereinbefore in relation to the leading side 53, 53b of blocking members 45 of the flow deflecting member 26 or the second flow deflecting member 26b. Similarly, all, or at least part, of the perimeter of the second trailing part side 54b corresponding to the blocking member 45 may have any profile described hereinbefore in relation to the trailing side 54, 54b of blocking members 45 of the flow deflecting member 26 or the second flow deflecting member 26b.

All, or at least part, of the perimeter of the leading side 53 corresponding to the supporting member 46 may have any profile described hereinbefore in relation to the leading side 53, 53a of supporting members 46 of the flow deflecting member 26 or the second flow deflecting member 26b. Similarly, all, or at least part, of the perimeter of the first trailing part 54a corresponding to the supporting member 46 may have any profile described hereinbefore in relation to the trailing side 54, 54a of supporting members 46 of the flow deflecting member 26 or the second flow deflecting member 26b. For example, the supporting member 46 of the third flow deflecting member 26c may adopt a tear-drop or alternative streamlined profile.

In some examples, the blocking member 45 may include a trailing extension 58 overhanging the first trailing part 54a.

Referring also to FIG. 18, a fourth flow deflecting member 26d is shown, in a cross-section along a mirror plane (x-z) of the fourth flow deflecting member 26d.

When viewed projected onto a plane parallel to the first axis 6 (i.e. side view), the fourth flow deflecting member 26d has the appearance of a quadrilateral, differing from the flow deflecting member 26 shown in FIGS. 14 to 15C in that the first θ₁₃ and second θ₁₄ interior angles are both equal to 90° so that the quadrilateral is a rectangle.

All, or at least part, of the perimeter of the leading side 53 corresponding to the blocking member 45 may have any profile described hereinbefore in relation to the leading side 53, 53b of blocking members 45 of the flow deflecting member 26 or the second flow deflecting member 26b. Similarly, all, or at least part, of the perimeter of the trailing side 54 corresponding to the blocking member 45 may have any profile described hereinbefore in relation to the trailing side 54, 54b of blocking members 45 of the flow deflecting member 26 or the second flow deflecting member 26b.

All, or at least part, of the perimeter of the leading side 53 corresponding to the supporting member 46 may have any profile described hereinbefore in relation to the leading side 53, 53a of supporting members 46 of the flow deflecting member 26 or the second flow deflecting member 26b. Similarly, all, or at least part, of the perimeter of the trailing side 54 corresponding to the supporting member 46 may have any profile described hereinbefore in relation to the trailing side 54, 54a of supporting members 46 of the flow deflecting member 26 or the second flow deflecting member 26b. For example, the supporting member 46 of the fourth flow deflecting member 26d may adopt a tear-drop or alternative streamlined profile.

In FIG. 18, the supporting member 46 is shown with a rectangular shape when viewed projected onto the plane parallel to the first axis 6 (i.e. side view), and the blocking member 45 extends upwards (positive y-direction as drawn) from the short side of the trapezium shape. However, in other examples, the blocking member 45 may include a trailing extension 58 overhanging the supporting member 46 and dividing the trailing side 54 in first 54a and second 54b trailing parts. Additionally or alternatively, the blocking member 45 may include a leading extension 59 overhanging the supporting member 46 and dividing the leading side 53 in first 53a and second 53b leading parts.

### Annular Insert

Referring also to FIGS. 19A to 19F, an annular insert 47 providing a flow deflecting member 26 is shown.

FIG. 19A is a projected view of the annular insert 47 from a front direction. FIG. 19B is a projected view of the annular insert 47 from a rear direction. FIG. 19C is a view of the annular insert 47 from a front direction (along the positive z-direction as illustrated). FIG. 19D is a cross section along the line labelled D-D* in FIG. 19C.

FIG. 19E is a view of the annular insert 47 from a rear direction (along the negative z-direction as illustrated). FIG. 19F is a top view of the annular insert 47.

Both of FIGS. 19C and 19E represent projections of the annular insert 47 onto planes perpendicular to the first axis 6 (in this case the z-direction as illustrated).

The annular insert 47 includes a cylindrical portion 60, having a flange 61 at a first end 62. A second end 53 of the annular insert 47 may be inserted into the first opening 7 of an ultrasonic meter, for example any of the first ultrasonic meter 1, the second ultrasonic meter 22, the dual-beam ultrasonic meter 23 or the tri-beam ultrasonic meter 27. The annular insert 47 could be used to provide the flow deflecting member 26 of the second dual-beam ultrasonic meter 44. The annular insert 47 should be pushed into the flow conduit 5 until the flange 61 abuts the end of the flow conduit 5 defining the first opening 7. The cylindrical portion 60 should fit tightly within the flow conduit 5.

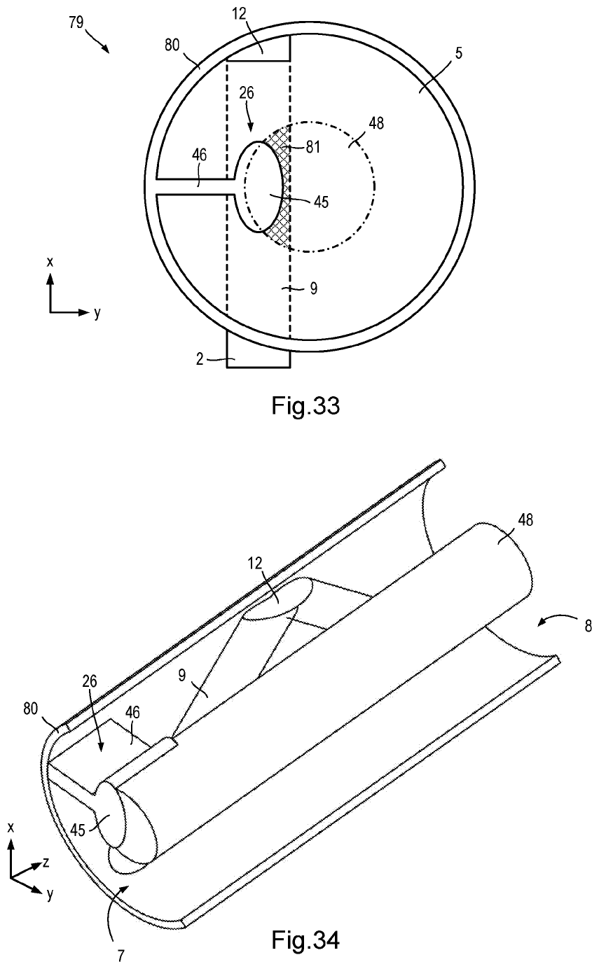

For ultrasonic meters 22, 23, 27 for which a projected intersection 25 may be defined, the size and position the blocking member 45 of the flow deflecting member 26 should be configured as described hereinbefore. For ultrasonic meters 1 including a single beam path 9, application of a flow deflecting member 26, 26b, 26c, 26d is described hereinafter with reference to FIGS. 33 and 34.

In the annular insert 47 shown in FIGS. 19A to 19F, the flow deflecting member 26 has a rounded bevel profile 55 around the perimeter of the leading side 53, and a sharp edge 57 (e.g. Kamm-tail profile) around the trailing side 54. In the annular insert 47 shown in FIGS. 19A to 19F, the flow deflecting member 26 is hollow, closed on the leading side 53, open on the trailing side 54, and defined by a wall 64. In the annular insert 47 shown in FIGS. 19A to 19F, the blocking member 45 has a substantially circular shape when projected onto a plane perpendicular to the first axis 6 (z-direction as illustrated), and is positioned to overlap a projected intersection 25 located at or close to the central axis of an ultrasonic meter 1, 22, 23, 27, 44.

In the annular insert 47 shown in FIGS. 19A to 19F, the cylindrical portion 60 includes rib structures 65 spaced at angular intervals around the perimeter and extending parallel to the first axis 6. The rib structures 65 may serve to facilitate insertion and retention of the cylindrical portion 60 within a flow conduit 5. The rib structures 65 may also assist with centring the insert 47 within the flow conduit 5.

Although the annular insert 47 shown in FIGS. 19A to 19F is illustrated for use with a cylindrical flow conduit 5, it may be adapted for any shape of flow conduit 5 by replacing the cylindrical portion 60 with an portion shaped to be just received within the flow conduit 5.

The annular insert 47 may be injection moulded or 3D printed from engineering plastics such as, for example, polyphenylene sulfide (PPS), high density polyethylene (HDPE), Polyoxymethylene composites (POMC), for example glass fibre reinforced/filled.

Referring also to FIGS. 20A and 20B, a second annular insert 47b is shown.

FIG. 20A is a view of the second annular insert 47b from a front direction (along the positive z-direction as illustrated). FIG. 20B is a cross section along the line labelled E-E* in FIG. 20A.

The second annular insert 47b is the same as the annular insert 47, except that instead of being formed from wall 64 to be hollow and open on the trailing side 54, the flow deflecting member 26 of the second annular insert 47b is solid.

### Examples of Projected Intersections

In examples hereinbefore, projected intersections 25 have been described between a pair of beam paths 9₁, 9₂ (see FIGS. 3 and 4) or between three beam paths 9₁, 9₂, 9₃ (see FIG. 5). However, the use of a flow deflecting member 26, 26b, 26c, 26d is not limited to projected intersections 25 which are centrally located within a flow conduit 5 and formed between equi-angularly spaced beam paths 9 which are essentially identical other than in orientation. In general, any set of two or more beam paths 9 may be projected onto a plane perpendicular to the first axis 6, and provided that the projection of at least one beam path 9 intersects the projection or at least one other beam path 9, a projected intersection 25 may be defined and there may be utility in placing a flow deflecting member 26, 26b, 26c, 26d so as to partially or entirely overlap the projected intersection 25.

For example, referring also to FIG. 21, a first exemplary beam configuration 66 (hereinafter “first beam configuration”) is shown, projected onto a plane (x-y as illustrated) perpendicular to the first axis 6 (z-direction as illustrated). In FIG. 21, ultrasonic transducers 2, 3 and reflectors 12 are omitted for simplicity of illustration.

The first beam configuration 66 is similar to that of the dual-beam ultrasonic meter 23 and/or the second dual-beam ultrasonic meter 44, except that instead of using a pair of “V” shaped beam paths 9 as illustrated in FIG. 1, the first beam path 9₁ is a V-shaped beam path 9 with a reflection as illustrated in FIG. 1, whilst the second beam path 9₂ is a straight-through angled beam path as illustrated in FIG. 2. This may be useful because, within a given length d of measurement region 13, the two beam paths 9₁, 9₂ may make different angles to the first axis 6.

In this configuration (and many other possible examples), there may not be any intersection of the actual volumes of the beam paths 9₁, 9₂. However, since fluid 29 flowing through the measurement region 13 should have a much larger component of velocity parallel to the first axis 6 than in any other direction, fluid 29 entering the first opening at a position corresponding to the projected intersection 25 will still (largely) flow through both beam paths 9₁, 9₂, leading to elevated sensitivity of an ultrasonic meter to fluid flows corresponding to the projected intersection 25.

Consequently, sensitivity of the first beam configuration 66 to changes in an incident flow speed profile with installation location may be reduced by including a flow deflecting member 26, 26b, 26c, 26d as described herein, and arranged to at least partially (and preferably fully) overlap the projected intersection 25.

Referring also to FIG. 22, a second exemplary beam configuration 67 (hereinafter “second beam configuration”) is shown, projected onto a plane (x-y as illustrated) perpendicular to the first axis 6 (z-direction as illustrated). In FIG. 22, ultrasonic transducers 2, 3 and reflectors 12 are omitted for simplicity of illustration.

In the second beam configuration 67, first 9₁, and second 9₂ beam paths are not equi-spaced about the first axis 6, in this illustrating making a 45° angle and defining a projected intersection 25 having the shape of a regular parallelogram. The first 9₁ and second 9₂ beam paths may have 3D shapes which are identical up to rotation about the first axis 6, as for the dual beam ultrasonic meter 23 or the second dual beam ultrasonic meter 44. Alternatively, the first 9₁ and second 9₂ beam paths may have 3D shapes which are different from one another, as for the first beam configuration 66.

In either case, sensitivity of the second beam configuration 67 to changes in an incident flow speed profile with installation location may be reduced by including a flow deflecting member 26, 26b, 26c, 26d as described herein, and arranged to at least partially (and preferably fully) overlap the projected intersection 25.

Referring also to FIG. 23, a third exemplary beam configuration 68 (hereinafter “third beam configuration”) is shown, projected onto a plane (x-y as illustrated) perpendicular to the first axis 6 (z-direction as illustrated). In FIG. 23, ultrasonic transducers 2, 3 are omitted for simplicity of illustration.

The third beam configuration 68 is similar to that of the tri-beam ultrasonic meter 27, except that instead of using a three “V” shaped beam paths 9 as illustrated in FIG. 1, each of the first 9₁, second 9₂ and third 9₃ beam paths is a straight-through angled beam path as illustrated in FIG. 2, with each of the first 9₁, second 9₂ and third 9₃ beam paths oriented at a different angle (between 10° and 80°) to the first axis 6.

As explained hereinbefore, even in the absence of any intersection of the actual volumes of the beam paths 9₁, 9₂, 9₃, a projected intersection 25 may still be defined, and sensitivity of the third beam configuration 68 to changes in an incident flow speed profile with installation location may be reduced by including a flow deflecting member 26, 26b, 26c, 26d as described herein, and arranged to at least partially (and preferably fully) overlap the projected intersection 25.

Referring also to FIG. 24, a fourth exemplary beam configuration 69 (hereinafter “fourth beam configuration”) is shown, projected onto a plane (x-y as illustrated) perpendicular to the first axis 6 (z-direction as illustrated). In FIG. 24, ultrasonic transducers 2, 3 and reflectors 12 are omitted for simplicity of illustration.

The fourth beam configuration 69 is the same as the first beam configuration 66, the configuration of the dual-beam ultrasonic meter 23 or the second dual-beam ultrasonic meter 44, except the first beam path 9₁ is offset from a centre of the flow conduit 5.

As explained hereinbefore, even in the absence of any intersection of the actual volumes of the beam paths 9₁, 9₂, a projected intersection 25 may still be defined, and sensitivity of the fourth beam configuration 69 to changes in an incident flow speed profile with installation location may be reduced by including a flow deflecting member 26, 26b, 26c, 26d as described herein, and arranged to at least partially (and preferably fully) overlap the projected intersection 25. Given the offset of the projected intersection 25, a corresponding flow deflecting member 26, 26b, 26c, 26d should be correspondingly offset from the centre of the flow conduit 5 so as to wholly or partially overlap the projected intersection 25.

In examples described hereinbefore, the intersection(s) of two or more beam paths 9 have, when viewed projected onto a plane perpendicular to the first axis 6, corresponded to a single, unified projected intersection 25. However, this is not always the case, and in some ultrasonic meters two or more distinct projected intersections 25 may be defined. Preferably, a separate flow deflecting member 26 should be positioned such that a projection thereof onto the plane perpendicular to the first axis 6 wholly or partially overlaps a respective projected intersection 25. In other words, a flow deflecting member 26 should be included for each distinct projected intersection 25.

For example, referring also to FIG. 25A, a fifth exemplary beam configuration 70 (hereinafter “fifth beam configuration”) is shown, projected onto a plane (x-y as illustrated) perpendicular to the first axis 6 (z-direction as illustrated). In FIG. 25A, ultrasonic transducers 2, 3 and reflectors 12 are omitted for simplicity of illustration.

In the fifth exemplary beam configuration 70, the projection of a first beam path 9₁ extends through the centre of the projected area of the flow conduit 5. The projection of a second beam path 9₂ extends perpendicular to the first beam path 9₁, and is offset from the centre of the flow conduit 5 in the negative x-direction as illustrated. The projection of a third beam path 9₃ extends perpendicular to the first beam path 9₁, and is offset from the centre of the flow conduit 5 in the positive x-direction as illustrated.

The projections of the first and second beam paths 9₁, 9₂ define a first projected intersection 25₁, and the projections of the first and third beam paths 9₁, 9₃ define a second projected intersection 25₂, entirely separate from the first projected intersection 25₁. Since fluid 29 entering the first opening 7 at a position corresponding to either of the projected intersections 25₁, 25₂ will be sampled by two beam paths 9, in the result is elevated sensitivity of an ultrasonic meter to fluid flows corresponding to the projected intersection 25.

Referring also to FIG. 25B, the sensitivity to changes in incident flow speed profile may be reduced as described hereinbefore by disposing a first flow deflecting member 26₁ to deflect fluid 29 away from the first projected intersection 25₁ and a second flow deflecting member 26₂ to deflect fluid 29 away from the second projected intersection 25₂.

FIG. 25B shows the fifth beam configuration 70, projected onto the same plane (x-y as illustrated) as FIG. 25A, with projections of the beam paths 9₁, 9₂, 9₃ omitted and projections of first 26₁ and second 26₂ projected intersections shown. The outlines of the first 25₁ and second 25₂ projected intersections are shown with dashed lines for comparison. In FIG. 25 B, ultrasonic transducers 2, 3 and reflectors 12 are omitted for simplicity of illustration.

FIGS. 25A and 25B show a particular example for illustrative purposes. In the general case, any number of projection intersections 25 may be formed between the projections of two, three or more beam paths 9, depending on the design of a particular ultrasonic meter. At least one, and preferably all, such projected intersections 25 should have a corresponding flow deflecting member 26. A pair of distinct projected intersections 25₁, 25₂ may be defined by intersections of projections of two beam paths 9 with a common beam path, for example the first 9₁, second 9₂ and third 9₃ beam paths of the fifth beam configuration 70. Alternatively, a pair of distinct projected intersections 25₁, 25₂ may be defined respectively be intersections of projections of first 9₁ and second 9₂ beam paths and third 9₃ and fourth (not shown) beam paths.

When two or more flow deflecting members 26 are included, these may be may identical (or at least blocking members 45 thereof may be identical) except in terms of relative position. Alternatively, and generally in dependence on the size, shape and/or position of the corresponding projected intersections 25, two or more flow deflecting members 26 may be different to one another.

Whilst examples have been described and shown in which beam paths 9 have been illustrated with equal beam widths wb, this is not essential, and different beam paths 9 may have differing effective beam widths wb, with predictable effects on shapes of projected intersections 25.

Whilst examples have been described and shown which include cylindrical fluid conduits 5, this is not essential, and in general the projection of the fluid conduit 5 onto the plane perpendicular to the first axis 6 may have any shape, for example square, elliptical, rectangular, or any other regular or irregular shape (though circular is expected to be the most common).

### Peak Flow Region and Flow Deflecting Members

As described hereinbefore, the effectiveness of the flow deflecting member 26 may be further increased if, in addition to at least partially overlapping a projected beam intersection, the flow deflecting member 26 also at least partially overlaps the projection of a peak flow volume 48 onto the plane perpendicular to the first axis 6.

The peak flow volume 48 corresponds to the volume through which a flow speed through a reference ultrasonic meter would be above a mean flow speed in response to passing a steady state fluid flow through the reference ultrasonic meter at a Reynolds number of approximately 3000. The reference ultrasonic meter in a given case corresponds to an ultrasonic meter which is identical except for omission of any flow deflecting members 26.

Referring also to FIGS. 26 to 28, the definition of a peak flow volume 48 shall be discussed in further detail.

Referring back in particular to FIG. 7A, this shows a contour plot of a flow speed profile for steady state flow though a cylindrical flow conduit 5. A flow-speed profile represents the component of velocity along the first axis 6 (z as illustrated herein). Denoting a flow-speed profile as u(x,y,z) and a flow-velocity profile as v(x,y,z), the two may be related as:

$$u ( x , y , z ) = {\underline{e}}_{z} \cdot \underline{v} ( x , y , z ) \qquad ( 4 )$$

For an ultrasonic meter 1, 22, 23, 27, 27, the peak flow region 48 may be defined relative to a projection onto a plane perpendicular to the first axis 6 of a flow conduit 5 of a reference ultrasonic meter which is identical to the ultrasonic meter except for omitting the flow deflecting member 26. For example, the dual-beam ultrasonic meter 23 corresponds to a reference ultrasonic meter for the second dual-beam ultrasonic meter 44, since the two differ only by the presence or absence of the flow deflecting member 26.

The peak flow region 48 is defined as corresponding to a region of the projection plane (perpendicular to the first axis 6) in which a flow speed u(x, y) through the reference ultrasonic meter is above a mean flow speed U in response to passing a steady state fluid flow through the reference ultrasonic meter. Since the boundary will vary with flow speed and other factors, the peak flow region is defined for a reference value which is a Reynolds number of approximately 3000, for example 3000±300.

Referring in particular to FIGS. 7A and FIG. 26, for a cylindrical flow conduit 5, the peak flow region 48 should be approximately circular, given the complete rotational symmetry of the flow speed profile u(x,y,z) about the first axis 6 for steady state flows (as illustrated in FIG. 7A). FIG. 26 shows, for the second dual-beam ultrasonic meter 44, the projections of the flow conduit 5 and the flow deflecting member 26 onto a projection plane (x-y as illustrated) perpendicular to the first axis 6 (z as illustrated). The flow conduit 5 has diameter D, and the peak flow region 48 takes the form of a concentric circular region of diameter Dₚ. In this instance, the ratio Dₚ/D is approximately ⅓.

Since the peak flow region 48 corresponds to the fastest flow in the reference ultrasonic meter (lacking any flow deflecting member), an ultrasonic meter will be more sensitive to deviations from the steady state flow speed profile within the peak flow region 48. Consequently, deflecting flows away from the peak flow region 48 using a flow deflecting member 26 may reduce the sensitivity of an ultrasonic meter to differences in incident flow speed profiles between a steady state condition used for calibration and an actual environment when installed.

The mean flow speed U may be determined by determining a volumetric flowrate (m³·s⁻¹) through the flow conduit 5 of the reference ultrasonic meter and dividing by a cross-sectional area (projected area on the projection plane) of the flow conduit 5. Volumetric flowrate may be experimentally measured using a pair of ultrasonic meters one of which includes flow deflecting member(s) 26, and one which does not. Additionally or alternatively, volumetric flowrate may be determined based on FEA simulations of an ultrasonic meter flow conduit 5 with and without flow deflecting member(s) 26.

When FEA simulations are performed, the mean flow speed U may alternatively be determined by integrating the simulated flow velocity field v(x,y,z) over the volume of the flow conduit 5 and normalising to the total volume of the flow conduit 5.

A projection of the flow velocity field v(x,y,z) onto a plane perpendicular to the first axis 6 may be defined as:

$$u ( x , y ) = {\int }_{0}^{L} \frac{\underline{v} ( x , y , z ) \cdot {\underline{e}}_{z}}{{L}_{c o n d}} d z \qquad ( 5 )$$

In which the unit vector ez is aligned with the first axis 6, L_{cond} is the length of the fluid conduit 5 parallel to the first axis 6 and u(x,y) is a (scalar) projected flow-speed profile. The value of the flow-speed profile u(x, y) at each position (x, y) is the average speed parallel to the first axis 6 along a line extending from that position (x, y) through the flow conduit 5. The peak flow region 48 may be defined based on the region(s) within which the flow-speed profile u(x, y) exceeds the mean flow speed U.

Instead of defining the peak flow region 48 as simply the locus for which flow speeds equal or exceed the mean flow speed U in the reference ultrasonic meter, i.e. u(x, y)>U, the peak flow region 48 may instead be defined to correspond to higher flow speeds. For example, if the maximum flow speed is uₘₐₓ, the peak flow region 48 may alternatively be defined to correspond to flow velocities greater than or equal to U+f (uₘₐₓ−U) with fbeing a fraction between 0.1≤f≤0.9.

Flow velocity fields v(x,y,z) in the reference ultrasonic meter in response to steady state fluid flow through the reference ultrasonic meter at a Reynolds number of approximately 3000 may be determined from theory, simulations and/or experimental measurements. The Reynolds number is defined as the product of the mean flow speed U and the hydraulic diameter, divided by the kinematic viscosity of the fluid 29, for example water, at a test temperature. It should be noted that the temperature is not important, since if the temperature changes, then the flow rate must change correspondingly to maintain the Reynolds number at the same value (and hence the same flow profile). Hydraulic diameter is defined as four times the area of the flow conduit 5 (perpendicular to the first axis 6), divided by the perimeter around that area. For a flow conduit 5 in the form of a cylinder, the hydraulic diameter is the cylinder diameter D, however, the same definition is applicable to non-cylindrical flow conduits 5.

Referring in particular to FIG. 27, the peak flow region 48 for a flow conduit 5 having a square cross-section of side length A is shown.

The peak flow region 48 is approximately square shaped (due to no slip boundary conditions) with a side length a. In reality the corners of contours of the flow speed profile will become increasingly rounded moving towards the centre of the flow conduit 5 (though this is not illustrated in FIG. 27).

Referring in particular, to FIG. 28, the peak flow region 48 for a flow conduit 5 having a rectangular cross-section of side lengths A and B is shown.

The peak flow region 48 is approximately rectangular shaped (due to no slip boundary conditions), with side lengths a and b. The ratios of side lengths will be substantially equal, i.e. a/A≈b/B. In reality the corners of contours of the flow speed profile will become increasingly rounded moving towards the centre of the flow conduit 5 (though this is not illustrated in FIG. 28).

Alternatively, the peak flow region 48 may be approximately defined without consideration of the precise details of fluid flows through the reference ultrasonic meter. This is possible with reasonable accuracy due to the predictable forms of steady state flow speed profiles (as illustrated in FIGS. 26 through 28). The peak flow region 48 may therefore be approximated as a region which:
has a centroid coinciding with the projected area of the flow conduit 5, for example concentric for a cylindrical flow conduit 5;
has the same shape and orientation as the projected area of the flow conduit 5; and
has one quarter or less of the projected area of the flow conduit 5.

For the example of the circular cross-section shown in FIG. 26, Dₚ=D/2 by the approximate definition. Similarly, for the square cross-section of FIG. 27, a=A/2, and for the rectangular cross-section of FIG. 28, a=A/2 and b=B/2.

If possible when considered in view of the location of one or more projected intersections 25, and in view of the need to avoid unacceptable pressure drops, when viewed projected onto the plane perpendicular to the first axis, it is preferable if at least half the projected area of the flow deflecting member 26 overlap the peak flow region 48. For a centrally positioned projected intersection 25, this condition may be relatively straightforward to achieve, for example, by adjusting the size of a blocking member 45 of the flow deflecting member 26.

### Combining Flow Deflecting Member(s) with Protrusions of WO 2019/229409 A1

Referring also to FIG. 29, a first combined ultrasonic meter 71 is shown.

The first combined ultrasonic meter 71 corresponds to the ultrasonic meter shown in FIG. 6 of WO 2019/229409 A1, modified to include a flow deflecting member 26 in addition to protrusions 72. The protrusions 72 have properties and/or structures, and are employed, as described in detail in WO 2019/229409 A1. Herein, we shall focus on explaining how to integrate flow deflecting members 26 described herein with protrusions 72 as described in WO 2019/229409 A1, so as to provide further ultrasonic meters having further reduced sensitivity to changes in incident flow speed profiles between deployment and calibration.

The first combined ultrasonic meter 71 is comparable to the first ultrasonic meter 1, except that it includes a flow deflecting member 26 and additional features relating to installation of the meter. For brevity, common parts will not be described a second time.

The flow conduit 5 in the first combined ultrasonic meter 71 is defined by the interior surfaces of a cylindrical tube 73, terminated at either end by a flange 74. The cylindrical tube 73 is positioned between a first pipe 75 and a second pipe 76 by bolts 77 passing through respective flanges 74 of the cylindrical tube 73 and pipes 75, 76. Joints between the cylindrical tube 73 and the pipes 75, 76 include gaskets (not shown) or other sealing means to prevent fluids from leaking. The flow path 4 may be either from the first opening 7 towards the second opening 8, or vice versa.

The first combined ultrasonic meter 71 includes a V-shaped beam path 9. One pair of ultrasonic transducers 2, 3 is illustrated in FIG. 29, but one or more other pairs of ultrasonic transducers 2, 3 are be oriented in planes outside the illustrated cross-section to define at least one further beam path 9. The effective cross-sectional areas of the beam paths 9 define the sampled volume(s) 13a and non-sampled volumes 13b of the measurement region 13 as described hereinbefore.

The first combined ultrasonic meter 71 differs from examples described hereinbefore primarily by the addition of one or more protrusions 72 extending along the first axis 6. At least part of each protrusion 72 is arranged to exclude fluid from at least part of one or more non-sampled volumes 13b of the measurement region 13. In this way, each protrusion 72 is configured to re-direct fluid out of the non-sampled volume(s) 13b and through the one or more beam paths 9 (sampled volumes 13a).

Another way to express the effect of the protrusions 72 is that each protrusion 72 acts to increase a mass fraction of the fluid 29 which intersects (passes through) the one or more beam paths 9. The increase in mass fraction is with respect to an ultrasonic meter (not shown) which is identical to the first combined ultrasonic meter 71, except for omission of the protrusions 72. A mass fraction of the fluid which intersects the one or more beam paths 9 may be defined as a mass of fluid which passes through the one or more beam paths 9 in unit time, divided by a mass of fluid which enters (or leaves) the flow conduit 5 via the first or second opening 7, 8 in unit time.

As described in WO 2019/229409 A1, re-directing fluid flows out of non-sampled volumes 13b and into sampled volumes 13a (through the beam paths 9) has an effect of reducing the sensitivity of an ultrasonic meter to disturbances of an incident flow speed profile from a steady state situation. When combined with flow deflecting member(s) described herein, the cumulative effect may be to provide an ultrasonic meter which has substantial immunity, i.e. <1.5% of reading error (see FIG. 13), to flow disturbances arising from a specific installation location. This may be compared to typical errors of the order of 10% without any mitigation measures.

Referring also to FIG. 30, a second combined ultrasonic meter 78 is shown.

The second combined ultrasonic meter 78 corresponds to the ultrasonic meter shown in FIG. 7 of WO 2019/229409 A1, modified to include a flow deflecting member 26 in addition to the protrusions 72.

The second combined ultrasonic meter 78 is the same as the first combined ultrasonic meter 71, except that the beam path(s) 9 do not include a reflection (as for the beam path 9 of FIG. 2). Only the centroid of the beam path 9 is shown in FIG. 30

### Exemplary Configuration of Protrusions

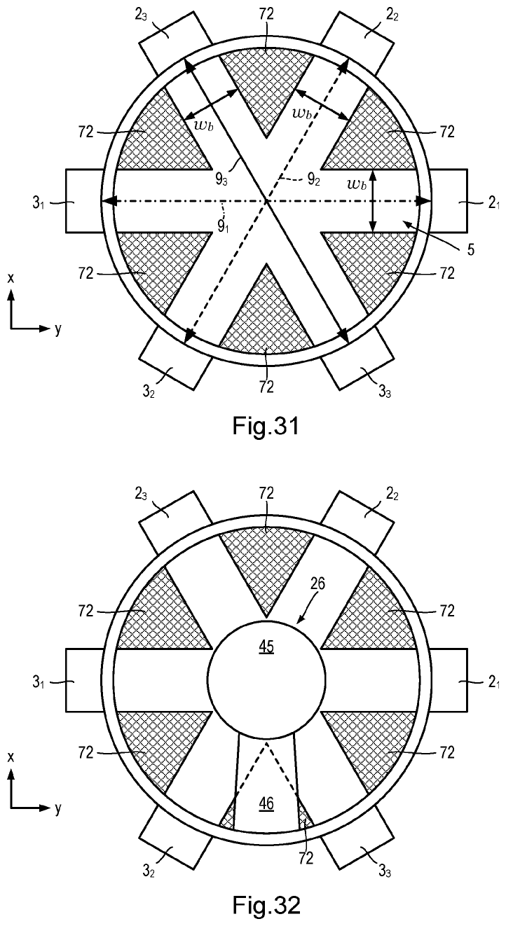

Referring also to FIG. 31, an exemplary configuration of protrusions 72 and beam paths 9 is shown.

A variety of alternative configurations for protrusions are described and illustrated in WO 2019/229409 A1, any of which may be combined with flow deflecting members 26, 26b, 26c, 26d described herein.

The exemplary configuration is a configuration of the second combined ultrasonic meter 78 using three pairs of ultrasonic transducers 2, 3 and six protrusions 72 spread around the perimeter of cylindrical flow conduit 5. A first pair of ultrasonic transducers 2₁, 3₁ are spaced on opposite sides of the flow conduit 5 to define a first beam path 9₁. A second pair of ultrasonic transducers 2₂, 3₂ are spaced on opposite sides of the flow conduit 5 to define a second beam path 9₂ which is rotated 60° anti-clockwise relative to the first beam path 9₁. A third pair of ultrasonic transducers 23, 33 are spaced on opposite sides of the flow conduit 5 to define a third beam path 9₃ having a transverse component which is rotated 60° clockwise relative to the first beam path 9₁. All of the ultrasonic transducers 2, 3 are still spaced apart along the first axis 6 so that each beam path 9₁, 9₂, 9₃ has a longitudinal component along the first axis 6 for measuring flow.

The protrusions 72 have a generally triangular cross-section extending into the flow conduit 5, and are spaced with respect to the first beam path 9₁ at angles of about 30, 90, 150, 210, 270 and 330 degrees. In this way, the beam paths 9₁, 9₂, 9₃ are located in spaces between the protrusions. Gaps between the protrusions 72 have a width w_{b} roughly corresponding to the effective width w_{b} of the beam paths 9₁, 9₂, 9₃. The effective width w_{b} of the beam paths 9₁, 9₂, 9₃ is typically less than a physical width of the transducers 2, 3. In this way, by excluding fluid flow from entering non-sampled volumes 13b between the beam paths 9₁, 9₂, 9₃, the protrusions 72 may act to re-direct substantially all of the fluid flowing through the measurement region 13 of the flow conduit 5 through beam paths 9₁, 9₂, 9₃. Consequently, average speeds measured using the first, second and third beam paths 9₁, 9₂, 9₃ may sample substantially all of the fluid flow. This may permit a mass flow to be estimated without a need to make an assumption about a flow speed profile across the flow conduit 5. In this way, the sensitivity of a combined ultrasonic meter 71, 78 to flow disturbances may be reduced.

Further, as the protrusions 72 leave a central region of the flow conduit 5 open, a combined ultrasonic meters 71, 78 may remain resistant to clogging with debris/fibres entrained in a fluid being measured.

The exemplary configuration of FIG. 31 has been illustrated with a cylindrical flow conduit 5. However, this arrangement is not essential, and in general the flow conduit 5 may take any shape described herein, without affecting the capability to utilise protrusions 72 as described in WO 2019/229409 A1.

Referring also to FIG. 32, placement of a flow deflecting member 26 relative to the exemplary configuration of protrusions 72 is shown.

FIG. 32 shows a projection of a second combined ultrasonic meter 78 using the exemplary configuration shown in FIG. 31, when viewed projected onto a plane perpendicular to the first axis and positioned upstream of the flow deflecting member 26. The flow deflecting member 26 includes a blocking member 45 and a supporting member 46 as described hereinbefore.

There are two options for the relative positioning of the flow deflecting member 26 about the perimeter. Firstly, as shown in FIG. 32, the flow deflecting member 26 may be arranged such that, when viewed projected onto a plane perpendicular to the first axis 6, a projection of the support member 46 at least partly overlaps with a projection of one of the protrusions. 72. For example, the projection of the support member may be aligned (centrally) with a projection of one of the protrusions.

Alternatively, the flow deflecting member 26 may be arranged such that, when viewed projected onto the plane perpendicular to the first axis 6, a projection of the support member 46 is aligned with a projection of at least one space/gap defined between a pair of protrusions 72. For example, the projection of the support member 46 may be aligned parallel with the projection of at least one beam path 9 passing between protrusions 72.

When protrusions 72 are included, some or all may be integrally formed as part of the flow conduit 5. Additionally or alternatively, some or all protrusions 72 may be included by securing an insert within the flow conduit 5, with the insert defining the protrusions.

### Non-Intersecting Beam Case

Some ultrasonic meters may include only a single beam path 9. Other ultrasonic meters may include multiple beam paths 9 which do not intersect, even when projected onto a plane perpendicular to the first axis 6.

Flow deflecting members 26, 26b, 26c, 26d described herein may still be used in such ultrasonic meters, in order to reduce the sensitivity of measurements to disturbances of an incident flow speed profile from a steady state condition.

Referring also to FIGS. 33 and 34, a single-beam ultrasonic meter 79 is shown. FIG. 33 is a projection onto a plane (x-y as illustrated) perpendicular to the first axis 6 (corresponding to the z-direction as illustrated). FIG. 34 is a projection view with a portion of a cylindrical pipe 80 defining the flow conduit cut-away for visibility.

In the illustration of FIGS. 33 and 34, the beam path 9 is of the V-shaped type illustrated in FIG. 1, and is offset from the centre of the flow conduit 5. However, these details are not essential, and beam path 9 may adopt any shape provided that substantially every part of the beam path 9 makes a non-zero angle with the first axis 6 (so that there is a component of flow velocity along the direction of the beam path 9).

When viewed projected onto the plane perpendicular to the first axis 6, a projection of the beam path 9 intersects the peak flow region 48. For example, see the intersecting region 81 in FIG. 33. The peak flow region 48 is defined as described hereinbefore (using the precise or approximated definitions). A flow deflecting member 26 is supported between the first opening 7 and the measurement region 13 so that, when viewed projected onto the plane perpendicular to the first axis 6, a projection of the flow deflecting member 26 at least partially overlaps the intersecting region 81 between the beam path 9 and the peak flow region 48. Preferably, the projection of the flow deflecting member 26 at least partially overlaps as much as possible of the intersecting region 81, though a balance may need to be made between overlapping a larger fraction of the intersecting region 81 and avoiding excessive pressure drops across the flow deflecting member 26. The flow deflecting member 26 may be configured and/or structured in any way described hereinbefore.

Although the single-beam ultrasonic meter 79 has been illustrated with the beam path 9 offset from the centre of the flow conduit 5, this is not required, and the beam path 9 may pass through the centre of the flow conduit 5.

If second or further beam paths 9 are present, and projections of the beam paths do not intersect, for example a pair of parallel beam paths 9, then a flow deflecting member 26 should preferably be positioned to at least partially overlap the intersection of each beam path 9 with the peak flow region 48.

Any ultrasonic meters 1, 22, 23, 27, 44, 71, 78, 79 may be used for metering flow of a fluid. Examples of fluids which are commonly metered include water such as for drinking, irrigation, or waste water, or natural gas.

### Modifications

It will be appreciated that many modifications may be made to the embodiments hereinbefore described. Such modifications may involve equivalent and other features which are already known in the design and use of ultrasonic meters, and which may be used instead of, or in addition to, features already described herein. Features of one embodiment may be replaced or supplemented by features of another embodiment.

Examples have been described in which a flow deflecting member 26, 26b, 26c, 26d is disposed between the first opening 7 and the measurement region 13. However, when an ultrasonic meter is desired to be operable for flows between first 7 and second 8 openings and also the reverse direction, corresponding flow deflecting member(s) 26, 26b, 26c, 26d may be disposed between the measurement region 13 and the second opening 8. For example, for each flow deflecting member 26 supported between the first opening 7 and the measurement region 13, an identical flow deflecting member (not shown) may be supported between the measurement region 13 and the second opening 8.

When viewed projected onto the plane perpendicular to the first axis 6, a projection of each flow deflecting member 26 supported between the first opening 7 and the measurement region 13 may entirely coincide with a projection of the corresponding flow deflecting member (not shown) supported between the measurement region 13 and the second opening 8. Each flow deflecting member (not shown) supported between the measurement region 13 and the second opening 8 may be a reflection of the corresponding flow deflecting member 26 supported between the first opening 7 and the measurement region 13, about a mirror plane perpendicular to the first axis 6. However, such a mirror plane does not need to coincide with a midpoint of the measurement region 13.

In examples described hereinbefore, flow deflecting members 26 have been described in which a blocking member 45 is held in place by a supporting member 46 configured so that, when viewed projected onto the plane perpendicular to the first axis 6 (e.g. x-y plane when the first axis 6 is parallel to z), the projection of the flow deflecting member 26 does not divide a projection of the flow conduit 5 into two separate regions.

However, in other examples it may be acceptable, even advantageous, if one or more through-holes are formed through the supporting member 46 to permit passage of fluid. For example, this may help to avoid a region of stagnant fluid immediately downstream of the supporting member 46.

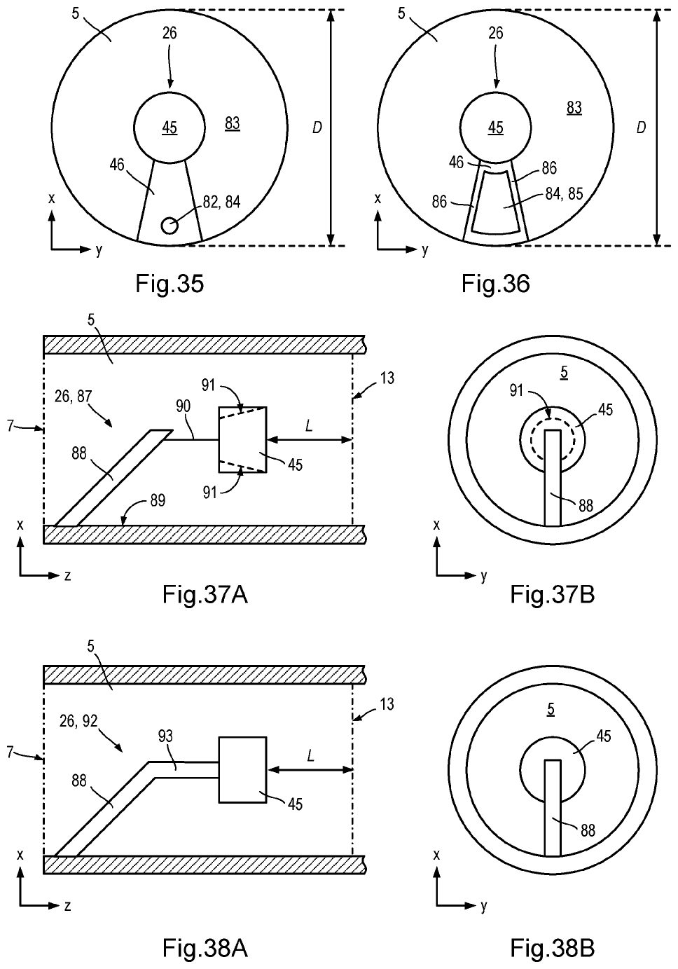

Referring also to FIG. 35, an example of a supporting member 46 including a through-hole 82 is shown.

FIG. 35 shows a view projected along the first axis 6 (z as illustrated). The through-hole 82 is in the form of a small circular hole extending through the supporting member 46 parallel to the first axis.

The through-hole 82 permits passage of fluid and prevents stagnation of fluid immediately behind the supporting member 46. Although the through-hole 82 may become clogged in the presence of a fluid entraining particles and/or fibres, it is apparent that the worst case scenario in which the through-hole 82 become blocked would still present a cross-section equivalent to the supporting member 46 without the through-hole. In this way, the flow conditioning device remains less susceptible to more extensive clogging (for example leading to significant pressure drops/restricted flow) when compared to prior art such as flow conditioning device 38.

Preferably, if the projection of the flow deflecting member 26 divides a projection of the flow conduit into two or more separate regions when viewed projected onto the plane perpendicular to the first axis, the projection of the flow deflecting member should divide a projection of the flow conduit into a primary region 83 and one or more smaller regions 84, such as through-hole 82. Preferably, an area of the primary region 83 in the projection accounts for 75% or more of the total projected area of the two or more separate regions 83, 84. In this way, even if the smaller regions 84 become clogged, the primary region 83 it likely to remain passable for flow.

Through-holes in the supporting member 46 are not limited to circular shapes such as through-hole 82, for example referring also to FIG. 36 a second example of a through-hole 85 in a supporting member 46 is shown.

The second example through-hole 85 has a cross-sectional shape which is the same as the supporting member 46, and of reduced area. This provides a supporting member 46 having a hollow, open-ended shape extending parallel to the first axis 6. The larger through-hole 85 may act to reduce a pressure drop of the flow deflecting member 26, and reduce the effects of the supporting member 46 on fluid flow. For example, the leading and trailing edges of sides 86 of the hollow-supporting member 46 may be streamlined to cut and connect streamlines (in contrast to the blocking member 45.

Similarly to the example of FIG. 35, in the event that the through-hole 85 does become blocked, the overall cross-section then becomes similar to the supporting member 46 without the through-hole 85, and so retains the reduced probability of clogging the primary region 83.

In general, a through-hole formed through the supporting member 46 may be elliptical, circular, square, rectangular, or any other regular or irregular shape in cross-section (when projected onto the plane perpendicular to the first axis).

Examples have been described in which the lengths of the supporting member 46 and blocking member 45 along the first axis 6 (z as illustrated) overlap. However, alternative configurations are possible for supporting the blocking member 45 in the desired position.

Referring also to FIGS. 37A and 37B a first alternative configuration 87 of a flow-deflecting member 26 is shown.

FIG. 37A shows a cross-section of the first alternative configuration 87 along a plane parallel to the first axis 6 (x-z plane as illustrated) and FIG. 37B shows a view of the first alternative configuration 87 along the first axis 6 (z as illustrated).

In the first alternative configuration 87, the flow deflecting member 26 includes a radial member 88 extending inwards from an inner surface 89 of the flow conduit 5. The radial member 88 is illustrated as being angled along the first axis 6, but in other examples could extend inwards perpendicularly to the first axis 6. The blocking member 45 is disposed within the fluid conduit 5 and offset along the first axis 6 away (positive z direction as illustrated) from the first opening 7 relative to the radial member 88. The blocking member held in place by a wire 90 extending along the first axis 6 from the radial member 88 to the blocking member 45. The wire 90 is preferably stiff to provide at least some mechanical constraint against deflection of the blocking member 45 perpendicular to the first axis 6. Although illustrated as being centrally disposed, appropriate placement and dimensions of the radial member 88 may allow the blocking member 45 to be disposed in any part of the flow conduit 5 cross-section described herein.

In this way, the effects of the structure supporting the blocking member 45 on the fluid flow may be reduced, which may reduce pressure drops and also asymmetry rotationally about the first axis 6. For example, the radial member 88 may be streamlined or otherwise shaped to minimise disruption to incident fluid flow. Combined with offsetting the blocking member 45 downstream of the radial member 88, which permits some recovery of flows divided by the radial member 88, the influence of the flow deflecting member 26 on fluid flows may be more dominated by the effect of the blocking member 45.

When the blocking member 45 is connected to the radial member 88 by a wire 90, there is a possibility of turbulent flows causing lateral back-and-forth motion of the blocking member 45. This may be counteracted by shaping a leading edge (relative to the first opening 7 and the radial member 88) of the blocking member 45 with a tapered profile 91. The tapering will interact with fluid flows such that a position of the blocking member 45 within the flow conduit will be stabilised by fluid flow from the first opening 7 towards the second opening 8. For example, the blocking member 45 may have a leading edge which is conical/pyramidal or frustoconical/frustopyramidal. The trailing edge (relative to the first opening 7 and the radial member 88) of the blocking member 45 should still be relatively sharp as described hereinbefore.

Referring also to FIGS. 38A and 38B a second alternative configuration 92 of a flow-deflecting member 26 is shown.

FIG. 38A shows a cross-section of the second alternative configuration 92 along a plane parallel to the first axis 6 (x-z plane as illustrated) and FIG. 38B shows a view of the second alternative configuration 92 along the first axis 6 (z as illustrated).

The second alternative configuration 92 is the same as the first alternative configuration 87, except that the wire 90 is replaced by a rigid rod 93. The rigid rod 93 preferably has as high a stiffness against bending as possible, for example the rigid rod may be hollow or have another cross-section configured for high flexural rigidity. Compared to the first alternative configuration 87, the rigid rod 93 may have a greater impact on fluid flows than the wire 90, bit provides greater stability of positioning the blocking member 45. The blocking member 45 may be shaped on the leading edge to use fluid flows to further enhance stability (as described in relation to the first alternative configuration 87), though this is not considered essential when supported by the rigid rod 93.

Examples have been described in which the flow deflecting member 26 includes a blocking member 45 disposed within the fluid conduit 5 and held in place by a single supporting member 46. As mentioned hereinbefore, in some examples there may be multiple supporting members.

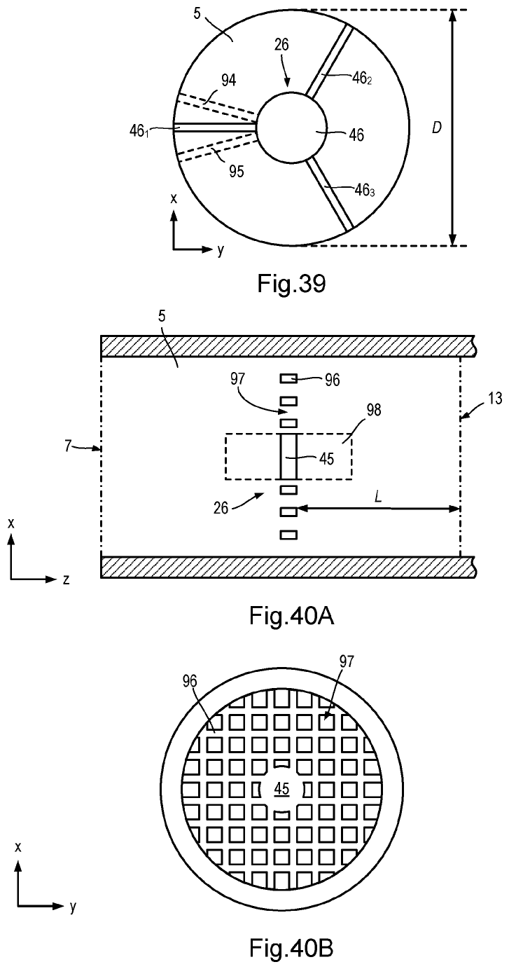

For example, FIG. 39 illustrates a configuration in which the blocking member 45 is supported by three supporting members 46₁, 46₂, 46₃.

The three supporting members 46₁, 46₂, 46₃ are equiangularly spaced about the first axis 6, in this example at 120° increments. Using a single supporting member 46 means that supporting member 46 must be sufficiently rigid to avoid undue deflection of the blocking member 45 from a desired position due to the forces applied by fluid flows. Multiple supporting members 46₁, 46₂, 46₃ spread about first axis 6 may be individually much smaller because in the example of FIG. 39 any lateral deflection of the blocking member 45 is opposed by extension of at least one of the supporting members 46₁, 46₂, 46₃. For example, each of the supporting members 46₁, 46₂, 46₃ may take the form of a length of wire.

Although dividing the flow conduit 5 into separate regions in this way makes the configuration with multiple supporting members 46₁, 46₂, 46₃ more susceptible to entangling materials entrained in the fluid flow, the total projected area of the supporting members 46₁, 46₂, 46₃ may be very small (for example individual wires) compared to the structure of prior art flow conditioners 38, so that the probability of clogging leading to significant pressure drops/reduced flow is still relatively reduced.

Whilst three supporting members 46₁, 46₂, 46₃ are shown in FIG. 39, similar effects may be obtained from fewer (for example two) or more (for example four) supporting members 46.

Alternatively, the second supporting member 46₂ may be moved to a second position 94 angled at 15° to the first supporting member 46₁. Similarly, the third supporting member 46₃ may be moved to a third position 95 angled at 15° to the first supporting member 46₁ so that the total angle subtended by all the supporting members 46₁, 46₂, 46₃ would be 30° (about the implied origin at the blocking member 45). The precise angle subtended is not critical. In this way, the configuration with multiple support members 46 may be arranged analogously to a single support member 46 including one or more through-holes 82, 85.

Stability of the blocking member 45 may be obtained by angling the support members 46 away from the perpendicular to the first axis 6. For example, the three supporting members 46₁, 46₂, 46₃ may be arranged in a tripod configuration.

Referring also to FIG. 40A and 40B, in a still further example the blocking member 45 may be supported by, or integrated with, a mesh 96.

FIG. 40A shows a cross-section of the configuration using mesh 96 along a plane parallel to the first axis 6 (x-z plane as illustrated) and FIG. 40B shows a view of the configuration 92 using mesh 96 the first axis 6 (z as illustrated).

The mesh 96 leaves gaps 97, and in the example shown in FIGS. 40A and 40B spans the entire flow conduit 4. In this example, the blocking member 45 is integrally formed with the mesh 96, for example the mesh 96 and blocking member 45 may be formed from a sheet of material by punching out the gaps 97 (or equivalent subtractive manufacturing method).

The mesh 96 configuration differs from the prior art flow conditioner 38 in that the mesh should be as thin as possible relative to the gaps 97. For example, the thickness of the mesh 96 parallel to the first axis 6 is preferably less than a dimension of gaps 97 (or through-holes) of the mesh 96, and more preferably less than or equal to half the dimension of gaps 97 of the mesh 96. Thus, unlike the flow conditioner 38, the gaps 97 of mesh 96 are not long enough (along the first axis 6) to force fluid into emerging as jets 41. This may prevent the mesh 96 from causing an undue pressure drop.

Pressure drops due to the mesh 96 may be additionally moderated by keeping the mesh 96 structure as thin as possible compared to the gaps 97, for example, when viewed projected onto the plane perpendicular to the first axis, the projected area of the mesh 96 structure may be less than or equal to 20% of the projected area of gaps 97 in the mesh 97 (excluding the projected area of the blocking member 45. In some examples, the mesh may be a wire-mesh.

Instead of being integrally formed with the mesh 96, the blocking member 45 may be attached to the mesh 96. When the blocking member 45 is attached to the mesh 96, the blocking member 45 may extend for a greater distance along the first axis 6 either upstream and/or downstream of the mesh 96. For example as indicated by the outline 98 shown in FIG. 40A.

Instead of covering the entire cross-section of the flow conduit 5, the mesh may cover a fraction of the cross-section of the flow conduit 5, for example a strip.

The mesh 96 is more susceptible to clogging compared to other structures described herein for supporting the blocking member 45. In some applications it may be intentional, for example to prevent particles traveling further in a system past the meter. The mesh 96 may be used to filter in addition to supporting the blocking member 45. Therefore, it may be advantageous for the mesh 96 to be easily removable for cleaning. When the blocking member 45 has equal thickness (along the first axis 6) to the mesh 96, the mesh and blocking member 45 (forming flow deflecting member 26) may be received through a slot in the flow conduit 5 (sealed around the mesh 96 by an O-ring for example). Alternatively, the mesh 96 may be supported by an insert (not shown) received into the first 7 or second 9 opening. In another example, the mesh 96 may be sandwiched between the flow conduit 5 and a connecting pipe, for example withing the flanges 74 between first pipe 75 and flow conduit 5 or second pipe 76 and flow conduit 5 as shown in FIG. 29 or 30, or between the flow conduit 5 and setter 28 shown in FIG. 6.

The mesh 96 within the area of the flow conduit 5 may be supported by a structure with a projected area of less than 25% of the flow conduit 5. The mesh 96 may have an outer frame (not shown) that strengthens the assembly of mesh 96 and blocking member 45 and provides a surface to seal against. The frame (not shown) may be outside the area of the inner diameter of the flow conduit 5.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicant hereby gives notice that new claims may be formulated to such features and/or combinations of such features during the prosecution of the present application or of any further application derived therefrom.

1. An ultrasonic meter for measuring a flow-rate of a fluid, comprising:
a flow conduit for the fluid, the flow conduit extending along a first axis between a first opening and a second opening;
two or more pairs of ultrasonic transducers, each pair of ultrasonic transducers configured to define a corresponding beam path intersecting the flow conduit within a measurement region of the flow conduit, wherein substantially every part of each beam path makes a non-zero angle with the first axis, and wherein when viewed projected onto a plane perpendicular to the first axis, a projection of a first beam path intersects a projection of a second beam path;
a flow deflecting member supported between the first opening and the measurement region, wherein when viewed projected onto the plane perpendicular to the first axis, a projection of the flow deflecting member at least partially overlaps the intersection of the projections of the first and second beam paths;
wherein the flow deflecting member is configured such that swirl is not introduced in response to a straight fluid flow passing the flow deflecting member.

2. The ultrasonic meter according to claim 1, wherein when viewed projected onto the plane perpendicular to the first axis, the projection of the flow deflecting member does not divide a projection of the flow conduit into two separate regions.

3. The ultrasonic meter according to claim 1, wherein when viewed projected onto the plane perpendicular to the first axis, the projection of the flow deflecting member divides a projection of the flow conduit into two or more separate regions including a primary region, wherein an area of the primary region in the projection accounts for 75% or more of the total projected area of the two or more separate regions.

4. The ultrasonic meter according to claim 1, wherein when viewed projected onto the plane perpendicular to the first axis, the projection of the flow deflecting member at least partially overlaps a peak flow region of the plane:
wherein the peak flow region is defined relative to a projection onto the plane of a flow conduit of a reference ultrasonic meter which is identical to the ultrasonic meter except for omitting the flow deflecting member;
wherein the peak flow region corresponding to a region of the plane in which a flow speed through the reference ultrasonic meter is above a mean flow speed in response to passing a steady state fluid flow through the reference ultrasonic meter at a Reynolds number of approximately 3000.

5. An ultrasonic meter according to claim 1, wherein the flow deflecting member is separated from the measurement region by a distance along the first axis which is between zero and 5 times a maximum dimension of the flow conduit perpendicular to the first axis.

6. An ultrasonic meter according to claim 1, wherein at least one of:
a leading side of the flow deflecting member facing towards the first opening has a rounded bevel profile around at least part of its perimeter and/or tapers towards the first opening;
wherein a trailing side of the flow deflecting member facing towards the measurement region has a sharp edge around at least part of its perimeter; and
when viewed projected onto a plane parallel to the first axis, the flow deflecting member has a quadrilateral shape.

7. (canceled)

8. (canceled)

9. An ultrasonic meter according to claim 1, wherein the flow deflecting member comprises a blocking member disposed within the fluid conduit and held in place by a supporting member.

10. An ultrasonic meter according to claim 9, wherein when viewed projected onto the plane perpendicular to the first axis, a projection of the supporting member connects to a projection of the blocking member along a connection direction, and a maximum dimension of the projection of the blocking member perpendicular to the connection direction is greater than a maximum dimension of the projection of the supporting member perpendicular to the connection direction.

11. An ultrasonic meter according to claim 1, wherein the flow deflecting member comprises:
a radial member extending inwards from an inner surface of the flow conduit;
a blocking member disposed within the fluid conduit and offset along the first axis away from the first opening relative to the radial member, the blocking member held in place by a rod or wire extending along the first axis from the radial member to the blocking member.

12. An ultrasonic meter according to claim 1, wherein the flow deflecting member comprises a blocking member disposed within the fluid conduit and held in place by two or more supporting members.

13. An ultrasonic meter according to claim 1, wherein the flow deflecting member comprises a blocking member disposed within the fluid conduit and held in place by a mesh.

14. (canceled)

15. An ultrasonic meter according to claim 9, wherein a length of the blocking member along the first axis is between 0.2 and 2 times a maximum dimension of the blocking member perpendicular to the first axis.

16. An ultrasonic meter according to claim 1, wherein the flow deflecting member does not include any portions which are conical, frustoconical, pyramidal, or frustopyramidal.

17. (canceled)

18. An ultrasonic meter according to claim 1, wherein a pressure drop across the flow deflecting member is 0.15 Pa or less in response to an average flow velocity in the flow conduit of 0.15 m·s⁻¹ of fluid in the form of water at 20° C.

19-22. (canceled)

23. An ultrasonic meter according to claim 1, wherein the flow deflecting member is a first flow deflecting member, and wherein when viewed projected onto the plane perpendicular to the first axis, a projection of a third beam path intersects a projection of a fourth beam path;
the ultrasonic meter further comprising:
a second flow deflecting member supported between the first opening and the measurement region;
wherein, when viewed projected onto the plane perpendicular to the first axis, a projection of the second flow deflecting member at least partially overlaps the intersection of the projections of the third and fourth beam paths.

24. An ultrasonic meter according to claim 1, wherein for each flow deflecting member supported between the first opening and the measurement region, an identical flow deflecting member is supported between the second opening and the measurement region.

25. An insert for an ultrasonic meter, the ultrasonic meter comprising:
a flow conduit for the fluid, the flow conduit extending along a first axis between a first opening and a second opening;
two or more pairs of ultrasonic transducers, each pair of ultrasonic transducers configured to define a corresponding beam path intersecting the flow conduit within a measurement region of the flow conduit, wherein substantially every part of each beam path makes a non-zero angle with the first axis, and wherein when viewed projected onto a plane perpendicular to the first axis, a projection of a first beam path intersects a projection of a second beam path;
the insert comprising a flow deflecting member configured such that, when the insert is received into the flow conduit:
the flow deflecting is supported between the first opening and the measurement region; and
when viewed projected onto the plane perpendicular to the first axis, a projection of the flow deflecting member at least partially overlaps the intersection of the projections of the first and second beam paths;
wherein the flow deflecting member is configured such that swirl is not introduced in response to a straight fluid flow passing the flow deflecting member.

26. An ultrasonic meter for measuring a flow-rate of a fluid, comprising:
a flow conduit for the fluid, the flow conduit extending along a first axis between a first opening and a second opening;
one or more pairs of ultrasonic transducers, each pair of ultrasonic transducers configured to define a corresponding beam path intersecting the flow conduit within a measurement region of the flow conduit, wherein substantially every part of each beam path makes a non-zero angle with the first axis, and wherein when viewed projected onto a plane perpendicular to the first axis, a projection of a first beam path intersects a peak flow region;
a flow deflecting member supported between the first opening and the measurement region, wherein, when viewed projected onto the plane perpendicular to the first axis, a projection of the flow deflecting member at least partially overlaps the intersection of the first beam path and the peak flow region;
wherein the peak flow region is defined relative to a projection onto the plane of a flow conduit of a reference ultrasonic meter which is identical to the ultrasonic meter except for omitting the flow deflecting member;
wherein the peak flow region corresponds to a region of the plane in which a flow velocity through the reference ultrasonic meter is above a mean flow velocity in response to passing a steady state fluid flow through the reference ultrasonic meter at a Reynolds number of approximately 3000;
wherein the flow deflecting member is configured such that swirl is not introduced in response to a straight fluid flow passing the flow deflecting member.

27. The ultrasonic meter according to claim 26, wherein:
when viewed projected onto the plane perpendicular to the first axis, the result of subtracting the projection of the flow deflecting member from the projection of the flow conduit is a continuously connected second region.

28. The ultrasonic meter according to claim 26, wherein when viewed projected onto the plane perpendicular to the first axis, the result of subtracting the projection of the flow deflecting member from the projection of the flow conduit is two or more separate regions including a primary region, wherein an area of the primary region in the projection accounts for 75% or more of the total projected areas of the two or more separate regions.

29-32. (canceled)
